(19) United States
(12) Patent Application Publication
(10) Pub. No.: US 2012/0179598 A1
(43) Pub. Date: Jul. 12, 2012

(54) Systems and Methods for Assessing Metrics of Loans, Financial Instruments and Financial Entities

(76) Inventor: Jason Roth, Burlingame, CA (US)

(21) Appl. No.: 13/004,785

(22) Filed: Jan. 11, 2011

Related U.S. Application Data
(60) Provisional application No. 61/430,900, filed on Jan. 7, 2011.

(51) Int. Cl. G06Q 40/00

(52) U.S. Cl. 705/38

(57) ABSTRACT

A method, system and computer program product for assessing performance metrics of loans, financial instruments and financial entities based on score values and/or characteristic models.

### CROSS-REFERENCE

This application claims priority from U.S. provisional patent application 61/430,900, filed on Jan. 7, 2011, which is incorporated herein in its entirety by reference.

### FIELD OF THE INVENTION

Embodiments of the present invention relate generally to systems and methods for assessing metrics of loans, financial instruments and/or financial entities using one or more data processing systems.

### BACKGROUND OF THE INVENTION

Individuals and other entities that are generally involved with the origination of loans often evaluate on a case by case basis whether to become involved in the origination of one or more particular loans. To make that decision, the individual or entity may want to assess the risks and benefits associated with the origination of the particular loan or loans by determining one or more corresponding performance metrics.

Loans associated with an individual or other entity can pose operational risks to that individual or other entity, including financial and regulatory risks. Consequently, individuals and other entities contemplating entering into a business transaction with that individual or entity may need to assess the operational risks that the loan or loans may pose to the individual or entity. To make that assessment, it may be helpful to employ one or more performance metrics for the respective loan or loans associated with that individual or entity.

There are a variety of operational risks posed by loans to an individual or other entity that originates such loans. Once a loan is originated, the originating individual or entity may retain all or a portion of the loan in its portfolio, and/or may sell all or a portion of the loan to another individual or other entity. In the case where the loan or a portion of the loan is sold to another individual or entity, there are various concerns that may compel the seller to assess the impact that the loan or portion of the loan may have upon the buyer, including a concern with preserving the reputation of the seller. If an individual or other entity that is involved with the origination of loans develops a negative reputation in the marketplace due to the impact that the sold loans or portions of loans have had upon buyers, it can negatively impact its ability to continue selling loans or portions of loans in the future. If the originating individual or entity retains all or a portion of a loan in its portfolio, the loan or portion of a loan, as an asset, will have a direct impact upon the operational performance of that individual or entity, as the sole or part owner.

On the other hand, loans are usually expected to generate a positive return for individuals or entities that hold full or partial ownership interest in them, so individuals or entities originating loans may also want to assess the expected performance of the loans that they originated. The expected positive return from such loans can be compared against the potential risks posed by those loans to evaluate the net expected value of the loans. This analysis may be performed for individual loans or for portfolios of multiple loans.

Consequently, in a variety of situations, including in the cases described above, it is desirable to understand the operational impact that portions of loans, individual loans and/or portfolios of multiple loans may have upon individuals or entities that originate, sell, buy, hold, trade, or otherwise manage such loans, and/or upon any individuals or entities that own or trade any partial or full interest in such loans.

To assist with the assessment of such operational impacts, there is a need for a system that can assess performance metrics for one or more loans, and/or for individuals or entities that may be associated with one or more loans.

### SUMMARY OF THE INVENTION

Various exemplary embodiments provide systems, methods, and computer program products for assessing a performance metric of a loan under consideration. In these exemplary embodiments, the assessment may be performed using a data processing system. The data processing system may comprise a logic module configured to receive at least one score value corresponding to at least one reference loan. The data processing may further comprise a logic module configured to compute at least one score value for the loan under consideration, wherein the computation is based on at least one of the score values received. The data processing may further comprise a logic module configured to assess the performance metric of the loan under consideration, wherein the assessment is based on at least one score value computed for the loan under consideration.

In one implementation, the performance metric is the risk of default of the loan under consideration. In one implementation, the performance metric is the risk of noncompliance of the loan under consideration with at least one regulation.

In one implementation, the performance metric is the risk of incidence of fraudulent activity associated with the loan under consideration.

In one implementation, the performance metric is the expected financial performance of the loan under consideration.

In one implementation, the financial performance of the loan under consideration is an expected financial loss or an expected financial gain.

In one embodiment, the performance metric of a loan under consideration is assessed using a data processing system that comprises a logic module configured to receive at least one characteristic model corresponding to at least one reference loan. The data processing may further comprise a logic module configured to compute at least one characteristic model for the loan under consideration, wherein the computation is based on at least one of the characteristic models received. The data processing may further comprise a logic module configured to assess the performance metric of the loan under consideration, wherein the assessment is based on at least one characteristic model computed for the loan under consideration.

### INCORPORATION BY REFERENCE

All publications, patents, and patent applications mentioned in this specification, if any, are herein incorporated by reference to the same extent as if each individual publication, patent, or patent application was specifically and individually indicated to be incorporated by reference.

### BRIEF DESCRIPTION OF THE DRAWINGS

The accompanying figures, which together with the detailed description below are incorporated in and form part of the specification, serve to further illustrate various embodiments and to explain various principles and advantages all in accordance with example embodiments of the present inventions.

FIG. 1 shows an example of a data processing system within which a set of instructions may be executed in connection with various embodiments of the present inventions.

FIG. 2 shows an exemplary data processing system configured to assess a performance metric of a loan under consideration in accordance with an embodiment of the present invention.

FIG. 3 shows another exemplary data processing system configured to assess a performance metric of a loan under consideration in accordance with an embodiment of the present invention.

FIG. 4A shows a flowchart illustrating the operation of an exemplary data processing system configured to compute a performance metric for a loan under consideration in accordance with an embodiment of the present invention.

FIG. 4B shows another flowchart illustrating the operation of an exemplary data processing system configured to compute a performance metric for a loan under consideration in accordance with an embodiment of the present invention.

FIG. 5 shows an exemplary data processing system configured to assess a performance metric of a loan under consideration in accordance with an embodiment of the present invention.

FIG. 6 shows another exemplary data processing system configured to assess a performance metric of a portfolio of loans under consideration in accordance with an embodiment of the present invention.

FIG. 7 shows another exemplary data processing system configured to assess a performance metric of a portfolio of loans under consideration in accordance with an embodiment of the present invention.

FIG. 8A shows a flowchart illustrating the operation of an exemplary data processing system configured to compute a performance metric for a loan portfolio under consideration in accordance with an embodiment of the present invention.

FIG. 8B shows another flowchart illustrating the operation of an exemplary data processing system configured to compute a performance metric for a loan portfolio under consideration in accordance with an embodiment of the present invention.

FIG. 9 shows an exemplary data processing system configured to assess a performance metric of a loan portfolio under consideration in accordance with an embodiment of the present invention.

FIG. 10 shows another exemplary data processing system configured to assess a characteristic metric of a financial entity based on a portfolio of loans under consideration in accordance with an embodiment of the present invention.

FIG. 11 shows another exemplary data processing system configured to assess a characteristic metric of a financial entity based on a portfolio of loans under consideration in accordance with an embodiment of the present invention.

FIG. 12A shows a flowchart illustrating the operation of an exemplary data processing system configured to compute a characteristic metric of a financial entity based on a portfolio of loans in accordance with an embodiment of the present invention.

FIG. 12B shows another flowchart illustrating the operation of an exemplary data processing system configured to compute a performance metric for a loan portfolio under consideration accordance with an embodiment of the present invention.

FIG. 13 shows an exemplary data processing system configured to assess a characteristic metric for a financial entity associated with a loan portfolio under consideration in accordance with an embodiment of the present invention.

FIG. 14 shows another exemplary data processing system configured to assess a characteristic metric of a financial instrument based on a portfolio of loans under consideration in accordance with an embodiment of the present invention.

FIG. 15 shows another exemplary data processing system configured to assess a characteristic metric of a financial instrument based on a portfolio of loans under consideration in accordance with an embodiment of the present invention.

FIG. 16A shows a flowchart illustrating the operation of an exemplary data processing system configured to compute a characteristic metric of a financial instrument associated with a portfolio of loans under consideration in accordance with an embodiment of the present invention.

FIG. 16B shows another flowchart illustrating the operation of an exemplary data processing system configured to compute a characteristic metric of a financial instrument associated with a portfolio of loans under consideration in accordance with an embodiment of the present invention.

FIG. 17 shows an exemplary data processing system configured to assess a characteristic metric for a financial instrument associated with a loan portfolio under consideration in accordance with an embodiment of the present invention.

FIG. 18 shows a flowchart illustrating the operation of an exemplary data processing system configured to compute a loan-related metric in accordance with an embodiment of the present invention.

### DETAILED DESCRIPTION

Various aspects of the invention claimed in the claims below may be better understood from the following description in conjunction with the referenced figures.

A data processing system, as applicable to various embodiments of the present invention, includes any desktop computer, laptop, netbook, electronic notebook, ultra mobile personal computer (UMPC), client computing device, server computer or server system (whether configured as a single server or as a bank of multiple servers), cloud computing system or platform, web appliance, network router, switch or bridge, mobile telephone, personal digital assistant, personal digital organizer, or any other computer system, device, component or machine capable of processing electronic data. In various implementations, a data processing system could act as a client, as a server, or as both a client and a server.

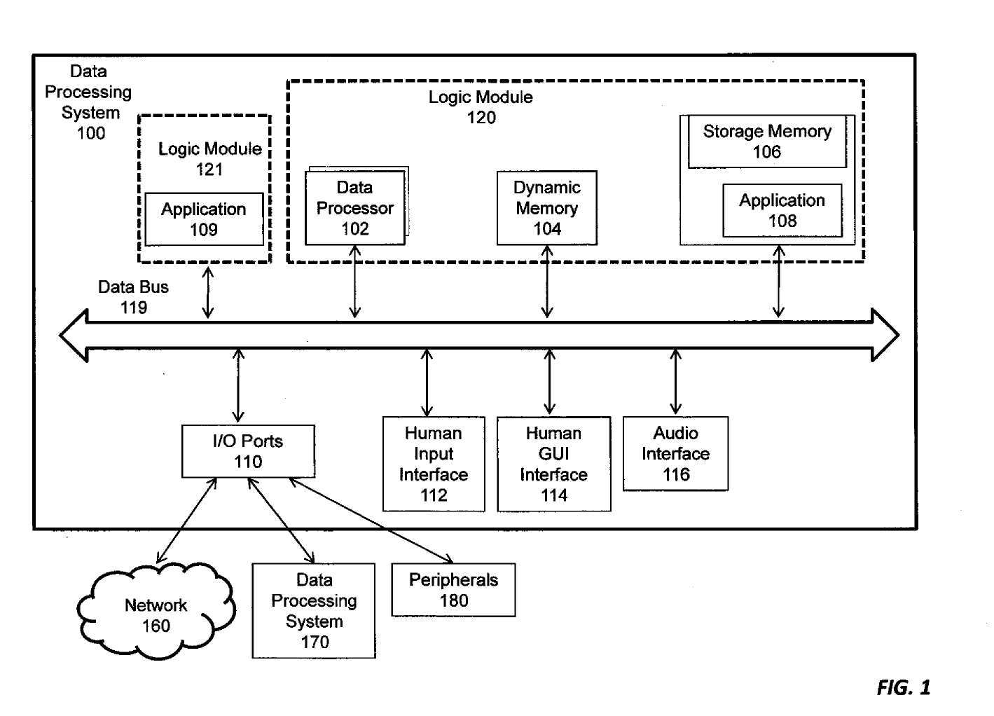

FIG. 1 shows a representation of an example of a data processing system 100 within which a set of instructions may be executed to perform any one or more of the methodologies discussed in this patent. The exemplary data processing system 100 includes a data processor 102.

Data processor 102 represents one or more general-purpose processing devices such as a microprocessor or other central processing unit. More particularly, the processing device may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets, whether in a single core or in a multiple core architecture. Data processor 102 may also be or include one or more special-purpose processing devices such as an application specific integrated circuit (ASIC), a field programmable gate array (FPGA), a digital signal processor (DSP), network processor, any other embedded processor, or the like. The data processor 102 may execute instructions for performing operations and steps in connection with various embodiments of the present invention.

In this exemplary embodiment, the data processing system 100 further includes a dynamic memory 104, which may be designed to provide higher data read speeds. Examples of dynamic memory 104 include dynamic random access memory (DRAM), synchronous DRAM (SDRAM) memory, read-only memory (ROM) and flash memory. The dynamic memory 104 may be adapted to store all or part of the instructions of a software application, as these instructions are being executed or may be scheduled for execution by data processor 102. In some implementations, the dynamic memory 104 may include one or more cache memory systems that are designed to facilitate lower latency data access by the data processor 102.

In general, unless otherwise stated or required by the context, when used in this patent in connection with a method, data processing system or logic module, the words “adapted” and “configured” are intended to describe that the respective method, data processing system or logic module is capable of performing the respective functions by being appropriately adapted or configured (e.g., via programming, via the addition of relevant components or interfaces, etc.), but are not intended to suggest that the respective method, data processing system or logic module is not capable of performing other functions. For example, unless otherwise expressly stated, a logic module that is described as being adapted to process a specific class of information will not be construed to be exclusively adapted to process only that specific class of information, but may in fact be able to process other classes of information and to perform additional functions (e.g., receiving, transmitting, converting and otherwise manipulating information).

In this exemplary embodiment, the data processing system 100 further includes a storage memory 106, which may be designed to store larger amounts of data. Examples of storage memory 106 include a magnetic hard disk and a flash memory module. In various implementations, the data processing system 100 may also include, or may otherwise be configured to access one or more external storage memories, such as an external memory database or memory data bank, which may either be accessible via a local connection (e.g., a USB or WiFi interface), or via a network (e.g., a remote cloud-based memory volume).

In general, a memory, memory medium, storage medium, dynamic memory, or storage memory, such as the memory media that could be used to implement the dynamic memory 104 and the storage memory 106, may include any chip, device, combination of chips and/or devices, or other structure capable of storing electronic information. A memory medium could be based on any magnetic, optical, electrical, mechanical, electromechanical, MEMS, quantum, or chemical technology, or any other technology or combination of the foregoing that is capable of storing electronic information. A memory medium could be centralized, distributed, local, remote, portable, or any combination of the foregoing. Examples of memory media include a magnetic hard disk, a flash memory module, a random access memory (RAM) module, and an optical disk (e.g., DVD, CD).

A software application or module that includes computer executable instructions (whether in source code or object code), and any other computer executable instructions may be stored on any such memory medium, whether permanently or temporarily, including on any type of disk (e.g., a floppy disk, optical disk, CD-ROM, and other magnetic-optical disks), read-only memory (ROM), random access memory (RAM), EPROM, EEPROM, magnetic or optical card, or any other type of media suitable for storing electronic instructions.

In general, a storage memory could host a database, or a part of a database. Conversely, in general, a database could be stored completely on a particular storage memory, could be distributed across a plurality of storage memories, or could be stored on one particular storage memory and backed up or otherwise replicated over a set of other storage memories. Examples of databases include operational databases, analytical databases, data warehouses, distributed databases, end-user databases, external databases, hypermedia databases, navigational databases, in-memory databases, document-oriented databases, real-time databases and relational databases.

Storage memory 106 may include one or more software applications 108, in whole or in part, stored thereon. In general, a software application, or data processing application (or, more succinctly, application, when used to reference software code) may include any software application, function, procedure, method, class or other process, whether implemented in programming code, firmware, or any combination of the foregoing. A software application may be in source code, assembly code, object code, or any other format. In various implementations, an application may run on more than one data processing system (e.g., using a distributed data processing model or operating in a computing cloud), or may run on a particular data processing system and may output data through one or more other data processing systems.

The exemplary data processing system 100 may include one or more logic modules 120 and/or 121 (also denoted data processing modules, or modules). Each logic module 120 and/or 121 may consist of (a) any software application, (b) any portion of any software application, where such portion can process data, (c) any data processing system, (d) any component or portion of any data processing system, where such component or portion can process data, and (e) any combination of the foregoing. In general, a logic module may be configured to perform instructions and to carry out the functionality of one or more embodiments of the present invention, whether alone or in combination with other data processing modules or with other devices or applications. Logic modules 120 and 121 are shown with dotted lines in FIG. 1 to further emphasize that data processing system 100 may include one or more logic modules, but does not have to necessarily include more than one logic module.

As an example of a logic module comprising software, logic module 121 shown in FIG. 1 consists of application 109, which may consist of one or more software programs and/or software modules. Logic module 121 may perform one or more functions if loaded on a data processing system or on a logic module that comprises a data processor.

As an example of a logic module comprising hardware, the data processor 102, dynamic memory 104 and storage memory 106 may be included in a logic module, shown in FIG. 1 as exemplary logic module 120. Other examples of logic modules comprising hardware include a desktop computer, a mobile computer, or a server computer, each being capable of running software to perform one or more functions defined in the respective software.

In general, functionality of logic modules may be consolidated in fewer logic modules (e.g., in a single logic module), or may be distributed among a larger set of logic modules. For example, separate logic modules performing a specific set of functions may be equivalent with fewer or a single logic module performing the same set of functions. Conversely, a single logic module performing a set of functions may be equivalent with a plurality of logic modules that together perform the same set of functions. In the data processing system 100 shown in FIG. 1, logic module 120 and logic module 121 may be independent modules and may perform specific functions independent of each other. In an alternative embodiment, logic module 120 and logic module 121 may be combined in whole or in part in a single module that perform their combined functionality. In an alternative embodiment, the functionality of logic module 120 and logic module 121 may be distributed among any number of logic modules. One way to distribute functionality of one or more original logic modules among different substitute logic modules is to reconfigure the software and/or hardware components of the original logic modules. Another way to distribute functionality of one or more original logic modules among different substitute logic modules is to reconfigure software executing on the original logic modules so that it executes in a different configuration on the substitute logic modules while still achieving substantially the same functionality.

The exemplary data processing system 100 may further include one or more input/output (I/O) ports 110 for communicating with other data processing systems 170, with other peripherals 180, or with one or more networks 160. Each I/O port 110 may be configured to operate using one or more communication protocols. In general, each I/O port 110 may be able to communicate through one or more communication channels.

A communication channel may include any direct or indirect data connection path, including any wireless connection (e.g., BlueTooth, WiFI, WiMAX, cellular, 3G, 4G, EDGE, CDMA and DECT), any wired connection (including via any serial, parallel, wired packet-based communication protocol (e.g., Ethernet, USB, FireWire, etc.), or other wireline connection), any optical channel, and any other point-to-point connection capable of transmitting data.

Each of the networks 160 may include one or more communication channels. In general, a network, or data network, consists of one or more communication channels. Examples of networks include LANs, MANs, WANs, cellular and mobile telephony networks, the Internet, the World Wide Web, and any other information transmission network. In various implementations, the data processing system 100 may include interfaces and communication ports in addition to the I/O ports 110.

The exemplary data processing system 100 may further include a human user interface 112, which provides the ability for a user to visualize data output by the data processing system 100. The human user interface 112 may directly or indirectly provide a graphical user interface (GUI) adapted to facilitate presentation of data to a user. The human user interface 112 may consist of a set of visual displays (e.g., an integrated LCD or CRT display), of a set of interfaces and/or connectors to an external visual display device (e.g., an LCD display or an optical projection device), or of a combination of the foregoing.

In general, a set means any group of one, two or more items. Analogously, a subset means, with respect to a group of N items, a set of such items consisting of N-1 or less of the respective items.

The exemplary data processing system 100 may further include one or more human input interfaces 112, which facilitate data entry by a user or other interaction by a user with the data processing system 100. Examples of human input devices 112 include a keyboard, a mouse (whether wired or wireless), a stylus, other wired or wireless pointer devices (e.g., a remote control), or any other user device capable of interfacing with the data processing system 100. In some implementations, human input devices 112 may include one or more sensors that provide the ability for a user to interface with the data processing system 100 via voice, or provide user intention recognition technology (including optical, facial, or gesture recognition), or gesture recognition (e.g., recognizing a set of gestures based on movement via motion sensors such as gyroscopes, accelerometers, magnetic sensors, optical sensors, etc.).

The exemplary data processing system 100 may further include an audio interface 116, which provides the ability for the data processing system 100 to output sound (e.g., a speaker), to input sound (e.g., a microphone), or any combination of the foregoing.

The exemplary data processing system 100 may further include any other components that may be advantageously used in connection with receiving, processing and/or transmitting information.

In the exemplary data processing system 100, the data processor 102, dynamic memory 104, storage memory 106, I/O port 110, GUI user interface 112, human input interface 114, audio interface 116, and logic module 121 communicate to each other via the data bus 119. In some implementations, there may be one or more data buses in addition to the data bus 119 that connect some or all of the components of data processing system 100, including possibly dedicated data buses that connect only a subset of such components. Each such data bus may implement open industry protocols (e.g., a PCI or PCI-Express data bus), or may implement proprietary protocols.

Some of the embodiments described in this specification may be presented in terms of algorithms and symbolic representations of operations on data bits within a computer memory. In general, an algorithm represents a sequence of steps leading to a desired result. Such steps generally require physical manipulations of physical quantities. Usually, though not necessarily, these quantities take the form of electrical or magnetic signals capable of being stored, transferred, combined, compared, and otherwise manipulated using appropriate electronic devices. Such signals may be denoted as bits, values, elements, symbols, characters, terms, numbers, or using other similar terminology.

When used in connection with the manipulation of electronic data, terms such as processing, computing, calculating, determining, displaying, or the like, refer to the action and processes of a computer system or other electronic system that manipulates and transforms data represented as physical (electronic) quantities within the system's registers and memories into other data similarly represented as physical quantities within the memories or registers of that system of or other information storage, transmission or display devices.

Various embodiments of the present invention may be implemented using an apparatus or machine that executes programming instructions. Such an apparatus or machine may be specially constructed for the required purposes, or may comprise a general purpose computer selectively activated or reconfigured by a software application.

Algorithms discussed in connection with various embodiments of the present invention are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language, data transmission protocol, or data storage protocol. Instead, a variety of programming languages, transmission or storage protocols may be used to implement various embodiments of the invention.

1. Single Loan Analysis

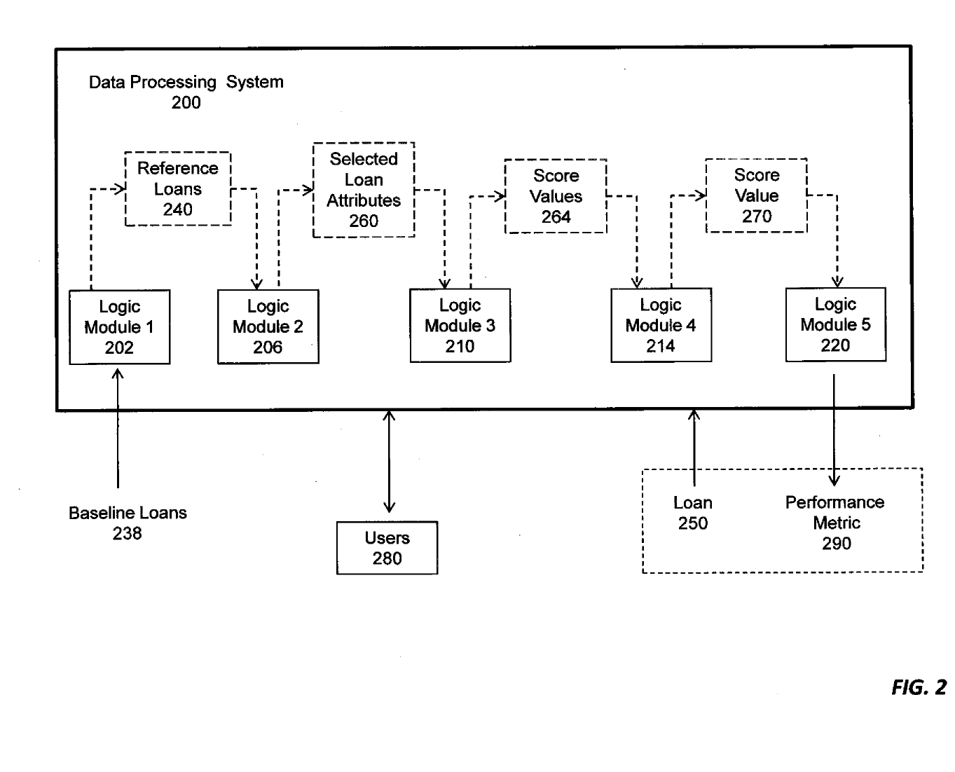

FIG. 2 shows an exemplary data processing system 200 configured to assess a performance metric of a loan under consideration in accordance with an embodiment of the present invention.

In various implementations, the loan under consideration may be the initiation, the refinancing or the modification of a mortgage loan for the purchase of a home or other real estate property, a loan for the purchase of a vehicle, any other secured loan where at least part of the loan is secured against an asset or some other interest, any unsecured loan, any demand loan, a loan for the purchase of one or more financial instruments, and any other financial instrument that relates to a debt-related transaction.

A loan is generally made by a lender and may be facilitated by one or more originators. The lender may be a financial institution (e.g., a bank), another private or commercial entity (e.g., a company, a hedge fund, an investment entity), an individual, or any other party able to lend money or other financial consideration. The originator may be directly employed by the lender or may be a third-party with which the lender has or contemplates having a business relationship.

A loan is generally made to a borrower. The borrower may be a private or commercial entity (e.g., a company, a hedge fund, an investment entity), an individual, a financial institution (e.g., a bank), or any other party willing to accept a loan and comply with any applicable legal obligations.

Generally, the borrower initially borrows an amount of money or some other financial consideration (denoted principal or borrowed amount), and agrees to pay back an equal amount of money or financial consideration, plus some additional money or other consideration (denoted interest or cost). The money or financial consideration may be paid back in fixed or variable installments which may include payment of both a portion of owed interest and a portion of owed principal or only a portion of owed interest. The interest to be paid to the lender is often defined as a percentage (denoted interest rate). The interest rate may be fixed or variable.

The data processing system 200 shown in the embodiment of FIG. 2 comprises logic module 1 202, logic module 2 206, logic module 3 210, logic module 4 214 and logic module 5 220 that are configured to perform various functions in connection with the computation of a performance metric 290 for a loan under consideration, denoted loan 250.

In one embodiment, logic module 1 202 is configured to select a set of reference loans 240. Reference loans 240 may be used in connection with the assessment of performance metric 290. In one implementation, some or all of the loans included in the reference loans 240 may have been previously processed in whole or in part to extract, partition or otherwise identify specific data within such loans (e.g., for example scanning a hard copy of a loan and performing optical character recognition to identify the identity of the respective borrower). Reference loans 240 are stored in one or more storage memories (not shown in FIG. 2) that are directly or indirectly accessible by logic module 1 202. For example, logic module 1 202 may access some or all of the reference loans 240 in a storage memory included within data processing system 200, or may retrieve reference loans 240 from an external storage memory that is located in a cloud computing system via a communication network. Alternatively, some or all reference loans 240 may be transmitted to logic module 1 202 via email, via FTP, or via any other communication method that could make reference loans 240 available to logic module 1 202.

In one embodiment, logic module 1 202 selects reference loans 240 from a larger set of loans included in baseline loans 238, using specific criteria. For example, logic module 1 202 may select loans with similar attributes to the loans for which performance metrics need to be generated such as selecting loans originated, closed, or funded within similar time-frames, loans with similar types of property securing the loans, loans with similar geographic locations of borrowers, or loans with similar geographic locations of properties securing the loans, or loans with any other attributes that would help ensure that the performance metrics of the selected loans will be relevant to the performance metrics of the loans for which performance metrics need to be generated.

Baseline loans 238 are stored in one or more storage memories (not shown in FIG. 2) that are directly or indirectly accessible by logic module 1 202. For example, logic module 1 202 may access some or all of the baseline loans 238 in a storage memory included within data processing system 200, or may retrieve baseline loans 238 from an external storage memory that is located in a cloud computing system via a communication network. Alternatively, some or all baseline loans 238 may be transmitted to logic module 1 202 via email, via FTP, or via any other communication method that could make baseline loans 238 available to logic module 1 202.

In one embodiment, the reference loans 240 are made available to the logic module 2 206, either by being transmitted directly or by being stored in a storage memory that is accessible to the logic module 2 206.

In one embodiment, each of the reference loans 240 has a characteristic set of attributes. Examples of such attributes include the identity or characteristics of the borrower, the identity or characteristics of the lender, the amount of the loan, the interest rate of the loan, the loan-to-value ratio of the loan transaction, fees or penalties charged on the loan, the purpose of the loan (e.g. whether the loan is for the purchase of new property, refinancing of existing debt or other general purpose), the occupancy of underlying property (e.g., for a real estate loan, whether the underlying property is a primary or a secondary residence), the features of underlying property (e.g., for a real estate loan, the number of occupancy units in the underlying property or what type of building the underlying property is), the location of the underlying property, or any other attributes that are considered relevant to the performance metrics that need to be generated.

In one embodiment, logic module 2 206 is configured to select at least one attribute of at least one of the loans included in the reference loans 240. In one implementation, logic module 2 206 may select a first set of attributes from one loan included in the reference loans 240 and may select a second set of attributes from a different loan included in the reference loans 240, where the first set and the second set of attributes may be the same, may be different, or may include some common attributes. The selected attributes are shown in the embodiment of FIG. 2 as selected loan attributes 260. For example, selected loan attributes 260 may consist of all attributes of all loans included in the reference loans 240. This may happen in a situation where the reference loans 240 do not include many attributes, or where the analysis performed is intended to maximize the data available. In another example, selected loan attributes 260 may consist of only one attribute of only one loan included in the reference loans 240. This may happen when the analysis seeks to minimize the input dataset, or where only one attribute of only one of the loans included in the reference loans 240 is considered relevant to the analysis. In general, selected loan attributes 260 may include any other number of attributes and/or reference loans, depending on the selection made by logic module 2 206. To select attributes for inclusion in the selected loan attributes 260, logic module 2 206 may take into account which attributes are expected to be available when the resulting performance metric is used, how relevant the attributes will be to the analysis, or any other criteria for selecting attributes that is appropriate for the baseline loans in question or the desired performance metric.

In one embodiment, the selected loan attributes 260 are then made available to the logic module 3 210, either by being transmitted directly or by being stored in a storage memory that is accessible to the logic module 3 210.

In one embodiment, logic module 3 210 is configured to compute one or more score values 264 for at least one of the reference loans included in the reference loans 240. In one implementation, if logic module 3 210 processes inconclusive data or otherwise encounters an inconclusive result, the logic module 3 210 may not compute any score value. This computation may be based on a subset of the attributes included in the selected loan attributes 260. In one case, score values 264 include exactly one score value for each of the reference loans included in the reference loans 240. In another case, score values 264 include more than one score value for each of the reference loans included in the reference loans 240. In another case, score values 264 do not include any score values for a subset of the reference loans included in the reference loans 240. In general, score values 264 may include zero or more score values for each of the reference loans included in the reference loans 240, but at least one of the reference loans included in the reference loans 240 will have at least one score value.

In one implementation, each of the score values included in score values 264 is a probability figure that indicates the likelihood that a relevant event will occur. For example, each of the score values included in score values 264 may indicate a probability that the corresponding loan included in the reference loans 240 may experience a default by the respective borrower. In another case, each of the score values included in score values 264 may indicate an expected amount of loss that may be incurred for the corresponding loan included in the reference loans 240. In another case, one score value included in score values 264 may indicate a probability that the corresponding loan included in the reference loans 240 may be out of compliance with one or more government requirements and a second score value included in score values 264 may indicate the expected amount of financial loss that may be incurred if the loan is out of compliance.

In one embodiment, to compute a score value included in the score values 264 for a particular reference loan (denoted Lₖ) included in the reference loans 240, logic module 3 210 may take into account defaults by the respective borrowers that occurred for other loans included in the reference loans 240 (denoted L₁, L₂, L₃ . . . Lₙ) and certain attributes of those loans L₁, L₂, L₃ . . . Lₙ. For example, if 80% of the loans L₁, L₂, L₃ . . . Lₙ had experienced a default by the respective borrowers and all of the loans L₁, L₂, L₃ . . . Lₙ are secured by properties located in a particular geographic area, if loan Lₖ is secured by a property located in that same particular geographic area, logic module 3 210 may assign a score value of 80% to loan Lₖ indicating that the expected probability of default for loan Lₖ is 80%. Logic module 3 210 may refine this score value further by taking into account additional attributes of loans L₁, L₂, L₃ . . . Lₙ and Lₖ, such as the income of the respective borrowers.

In one implementation, to arrive at a final score value for a particular loan included in the reference loans 240, logic module 3 210 may adjust the score computations to provide a more even distribution of loans that are assigned to particular score ranges or to present assigned scores on a different scale. For example, in the case where the assigned score values represent the likelihood that a loan will be out of compliance with one or more government requirements, logic module 3 210 may adjust assigned score values so that, when arranging the population of reference loans in order with those with the lowest adjusted assigned score value first and those with the highest adjusted assigned score value last, starting from the loan with the lowest adjusted assigned score value and counting forward the number of loans in the population of reference loans that are actually out of compliance with one or more government requirements, the number of loans actually out of compliance with one or more government requirements increases as close to linearly as possible.

According to an embodiment of the invention, in some instances it may be advantageous to have more evenly distributed assigned score values. For example, if the desired performance metric indicates which loans represent too much risk of being out of compliance with one or more government requirements, assigned score values for the population of reference loans may be intended to range on a numeric scale from 0 to 1000, with lower numbers representing lower risk and higher numbers representing higher risk. If all assigned score values occur initially within a narrow range of values or are clustered within a few narrow ranges of values (e.g., if all of the assigned score values fall within the ranges from 500 to 501 and 200 to 201), it may be difficult to derive useful performance metrics using the scores. In this example, a performance metric could be derived by using the assigned score value (e.g., the performance metric could be that loans with assigned score values of 500 and above represent too much risk of being out of compliance with one or more government requirements so as to be detrimental to institutions associated with the loans and should be excluded from consideration for a particular decision involving the loans). With score values narrowly clustered, in this example, the performance metric would be limited to indicating that loans in only one narrow score range, 200 to 201, represent an acceptable risk of being out of compliance with one or more government requirements. If only a small number of loans were assigned a score value in the range 200 to 201, the performance metric would exclude many loans from consideration for a particular decision involving the loans. In this case, it would be difficult to adjust the performance metric to exclude fewer loans without the performance metric also including the loans with score values within the range 500 to 501, thus never excluding any loans and thus providing no information about the loans under consideration.

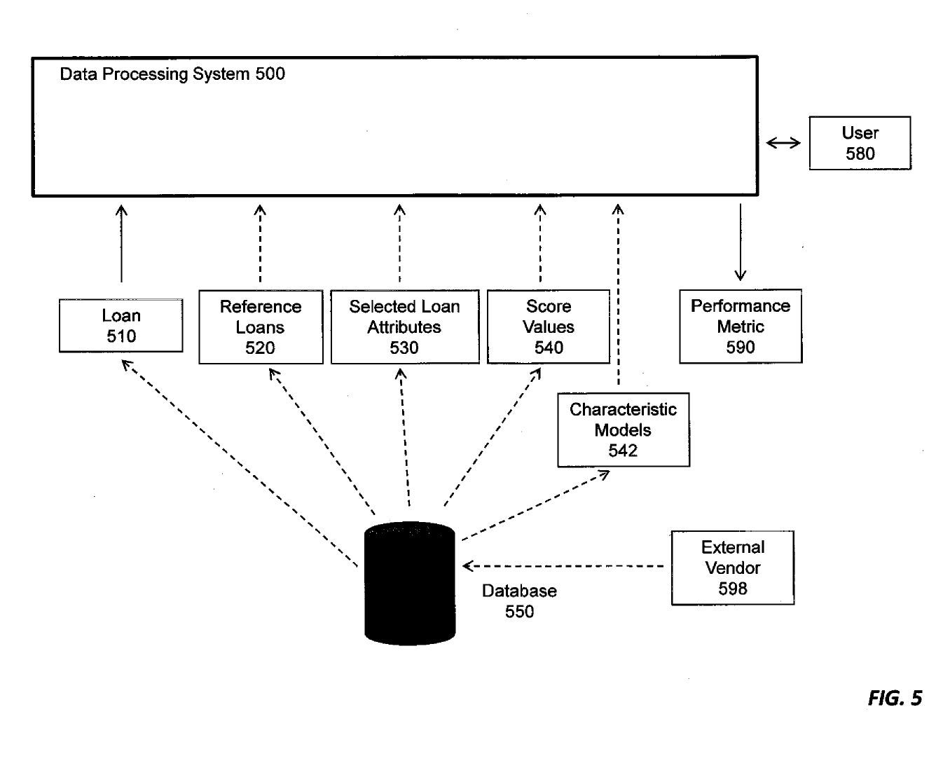

In one embodiment, the computed score values 264 are stored in a storage memory for future reference, either together with the corresponding loans included in the reference loans 240 or separately. An advantage of storing the score values 264 for future reference is that they would not have to be recomputed for subsequent analysis. Also, if the score values 264 are available in a storage memory and may be retrieved in connection with corresponding reference loans, a data processing system that computes a performance metric would be able to skip the intermediate processing required for the computation of the score values 264. FIG. 5 shows an embodiment in which score values corresponding to certain reference loans are retrieved from an external storage memory to be used by a data processing system for the computation of a performance metric. In various implementations, score values could also be received, or otherwise retrieved, from a local storage memory or from any other source.

In one embodiment, the computed score values 264 are then made available to the logic module 4 214, either by being transmitted directly or by being stored in a storage memory that is accessible to the logic module 4 214.

In one embodiment, logic module 4 214 is configured to compute a score value 270 that consists of one or more individual score values for the loan 250. This computation may be based on the computation of one or more of the score values 264. The score value 270 may include a probability figure that indicates the likelihood that an event relevant to loan 250 will occur, and/or a dollar amount that indicates the likely amount of financial loss associated with loan 250. Computation of the score value 270 may be made using a process analogous with the process described above for the computation of the score values 264.

In one embodiment, the score value 270 is made available to the logic module 5 220, either by being transmitted directly or by being stored in a storage memory that is accessible to the logic module 5 220. In one implementation, the score value 270 is also stored in a storage memory for future reference, either together with the loan 250 or separately. An advantage of storing the score value 270 for future reference is that it would not have to be recomputed for subsequent analysis. In one implementation, the score value 270 is stored together with the score values 264 for possible future retrieval.

In one embodiment, logic module 5 220 is configured to compute a performance metric 290 for the loan 250.

An example of performance metric 290 is the risk of default of a loan. In general, a loan has a characteristic risk of default with a probability between 0% and 100%. The risk of default may vary in time. It is generally advantageous to be able to estimate the risk that the borrower will default in repaying a loan. For example, assessing the risk of default of a loan before the loan is made would allow the lender to decide whether to extend the loan at all and/or would assist the lender in correlating the interest rate of the loan with the risk of default. Assessing the risk of default of a loan after the loan is made would facilitate valuation of the loan, including in connection with the sale of the loan, with the sale to investors of securities or other interests into the loan (whether individually or together with other loans or other financial instruments), and the valuation of the lender. Default on a loan may occur as a result of a variety of factors, including a change in circumstances of the borrower, increases in the interest rate of the loan, changes in the contractual terms relating to the loan, and macroeconomic events.

Another example of performance metric 290 is the risk of noncompliance with at least one applicable law, government rule or regulation, market requirement, or other applicable legislation or constraints that may be imposed by any governmental authority, administrative authority or other entity. In general, a loan has to comply with a variety of government and market requirements. Examples of government and market requirements that may put a loan at risk for non-compliance include: defined maximum amounts or thresholds on rates and fees that may be charged on a loan, required accuracy of consumer disclosures regarding the cost of a loan, required timing of delivery of consumer disclosures regarding the cost of a loan, limits on penalties that may be assessed for violation of the terms of a loan, restrictions on when particular events associated with a loan are allowed to occur, limits on particular fees or sets of fees, or any other restriction or requirement that may affect a loan. Being out of compliance with at least one applicable law or government or market requirement or constraint can result in a loan not being marketable, not being insurable, not being eligible for one or more government programs, causing parties associated with the loan to lose various business licenses, resulting in fines or sanctions to parties associated with the loan, and other negative financial and regulatory consequences.

Various systems and methods for automatically determining whether loans must comply with applicable legislation, and whether they actually comply with applicable legislation, are described in U.S. Pat. No. 7,386,505, titled “System and Method for Automated Compliance with Loan Legislation,” based on application Ser. No. 10/609,721, and issued to LogicEase Solutions, Inc., which is the assignee of the present application; the U.S. Pat. No. 7,386,505 patent is hereby incorporated by reference in its entirety.

Another example of performance metric 290 is the risk of incidence of fraudulent activity on a loan. In general, a loan may be subjected to fraudulent activity. Fraudulent activity could occur during the loan application process, when the borrower submits an application for the loan, or may occur at a later time. Fraudulent activity may be direct, in the case of a deliberate fraud, or indirect, in the case of information being provided without an appropriate amount of attention to quality control or due-diligence. Examples of fraudulent activities that may affect loans include a borrower, a loan originator, or any party associated with a loan directly or indirectly misrepresenting information associated with the loan, a borrower, a loan originator, a property appraiser, or any party associated with a loan directly or indirectly misrepresenting information associated with an asset securing the loan, or an unaffiliated third-party directly or indirectly misrepresenting information associated with a loan. Terms of a loan are often based on attributes of the borrower or borrowers as well as collateral associated with the loan, if any. If information about the borrower or collateral associated with a loan is not correct, the terms of the loan may not correctly address potential risks associated with the borrower and the collateral, if any collateral is associated with the loan.

Another example of performance metric 290 is the expected financial performance of a loan. A lender making a loan would generally expect to make a profit from the loan, normally by charging a sufficiently high interest rate for the loan. The lender may incur certain costs in connection with extending a loan, however, so the profit that the borrower realizes from the loan must exceed the lender's costs to produce a net financial gain for the lender. Examples of costs that a lender may incur in connection with a loan include expenses or costs for any underlying debt that the lender may assume to obtain money that the lender can then make available to the borrower under the loan and costs to employ personnel and infrastructure associated with the origination and administration of the loan. A lender may also incur a cost for a loan if the borrower defaults under the loan or otherwise fails to pay back the interest amount originally expected by the lender or if any collateral associated with the loan decreases in value from the amount originally expected by the lender.

The probability that a borrower will comply with the terms and conditions of a loan, and therefore fully pay back the amount that the lender expects through the initial applicable contractual arrangement, is usually between 0% and 100%. Consequently, it makes sense to assess the expected financial performance of a loan in terms of expected values, obtained by multiplying (a) the total amount that the borrower is expected to pay back in the event of full compliance with the terms and conditions of the loan, by (b) the probability that the borrower will actually pay back this total amount. In one embodiment of the invention, the expected financial performance of a loan that is assessed is an expected financial gain. In one embodiment of the invention, the expected financial performance of a loan that is assessed is an expected financial loss.

In one embodiment, logic module 5 220 computes the performance metric 290 based on the score value 270.

The process used for the computation of the performance metric 290 may depend on the nature of the performance metric 290. One or more values in score value 270 may correspond to one or more possible scenarios, depending on the nature of the performance metric 290, which will then result in the computed performance metric 290.

In one example, the score value 270 can range from 0 to 1000 and represents the likelihood of a loan to be out of compliance with one or more government requirements. In this example the performance metric 290 may be an indicator that a loan represents an unacceptable risk to an institution due to its likelihood of being out of compliance with one or more government requirements. In this example, if the score value 270 is 200 or greater, the performance metric 290 indicates that the loan represents an unacceptable risk to an institution due to its likelihood to be out of compliance with one or more government requirements. In this example, logic module 5 220 computes the performance metric by examining the score value 270 to see whether it is 200 or greater and uses that information to compute the performance metric 290.

In another example, the score value 270 can range from 0 to 1000 and represents the likelihood that a loan will go into default. In this example the performance metric 290 may be an indicator that a loan should be purchased at a lower price in a secondary market in order to compensate for the likelihood of default on the loan. In this example, if the score value 270 is 500 or greater, the performance metric 290 may indicate that the loan should be purchased for at most 90% of its price at par, and if the score value is less than 500, the performance metric 290 may indicate that the loan should be purchased for at most 100% of its price at par. In general, for a financial asset such as a loan, the price at par means a price established for that asset based on inherent characteristics of the asset (e.g., for a loan, such characteristics could include the terms of the loan, the interest rate and/or the maturity date) and an applicable valuation model (e.g., an accounting model that takes into account a discount rate). In this example, logic module 5 220 computes the performance metric by examining the score value 270 and uses that information to compute the performance metric 290.

In another example, the score value 270 can range from 0 to 1000 and represents the likelihood of incidence of fraudulent activity on a loan. In this example the performance metric 290 may be an indicator of the level of detail of additional file review that a loan should be subjected to in order to look for evidence of fraudulent activities prior to funding the loan. In this example, if the score value 270 is between 0 and 400 inclusive, the performance metric 290 may indicate that the loan can be funded without any additional file review, if the score value 270 is between 401 and 800 inclusive, the performance metric 290 may indicate that the loan cannot be funded without an additional review of the loan application to verify information that a borrower submitted in connection with the loan, and if the score value 270 is greater than 800, the performance metric 290 may indicate that the loan cannot be funded without a complete review and re-underwriting of the entire loan file to review all aspects of the loan in detail. In this example, logic module 5 220 computes the performance metric by examining the score value 270 and uses that information to compute the performance metric 290.

In another example, the score value 270 can range from 0 to 1000 and represents the expected financial performance of a loan. In this example the performance metric 290 may be an indicator of whether the loan should be added to an existing security instrument. In this example, if the score value 270 is 500 or greater, the performance metric 290 may indicate that the loan's expected financial performance is likely to meet the target return of an existing security and could be added to the security without the likelihood of impairing the security's target financial performance, and if the score value 270 is less than 500, the performance metric 290 may indicate that the loan's expected financial performance is likely to underperform the target return of an existing security and would be likely to impair the security's target financial performance if the loan were to be added to the security. In this example, logic module 5 220 computes the performance metric by examining the score value 270 and uses that information to compute the performance metric 290.

In the data processing system 200 described in connection with the embodiment of FIG. 2, logic module 1 202, logic module 2 206, logic module 3 210, logic module 4 214 and logic module 5 220 are independent modules and perform their respective functions independent of each other. In alternative embodiments, one or more of logic module 1 202, logic module 2 206, logic module 3 210, logic module 4 214 and logic module 5 220 may be combined in whole or in part in one or more logic module that perform all or part of the functionality of each of the respective modules. For example, logic module 1 202 and logic module 2 206 could be combined in a single logic module that is configured to perform the functionality of both logic module 1 202 and logic module 2 206, including selecting reference loans 240 and selecting selected loan attributes 260.

In the embodiment of FIG. 2, one or more human users 280 interact with the data processing system 200. Users 280 may perform various functions relating to the configuration of the data processing system 200, including programming and/or maintaining data processing system 200 or its constituent logic modules. Users 280 may also represent operators of the data processing system 200, such as an employee working for a lender and using data processing system 200 to process loans, or a government employee using data processing system 200 to verify loan compliance.

In one implementation, at least one of the users 280 accesses data processing system 200 directly via a human input device (e.g., a keyboard). This may happen, for example, when data processing system 200 is a desktop computer and a user is operating the desktop computer directly. In another implementation, at least one of the users 280 accesses data processing system 200 via a communication network. This may happen, for example, when data processing system 200 is a server computer or a service operating in a cloud system, and a user is logging into the server or cloud system remotely.

The access of users 280 to data processing system 200 may be regulated using a security clearance model based on credentials of specific human users 280. For example, a more limited credential profile for a non-managerial employee could permit the respective human user to only access specific functions of the data processing system 200 or to only process specific loans. Such a security clearance model could be implemented using a login (e.g., username and password) validation model.

Users 280 may also access data processing system 200 indirectly via one or more separate portals or systems, interacting directly or indirectly with data processing system 200.

The performance metric 290 and all other data produced and/or output by data processing system 200 may be formatted in any file format or using any data format protocol, and may be displayed on a screen, exported, downloaded, emailed or otherwise made available to the respective users 280.

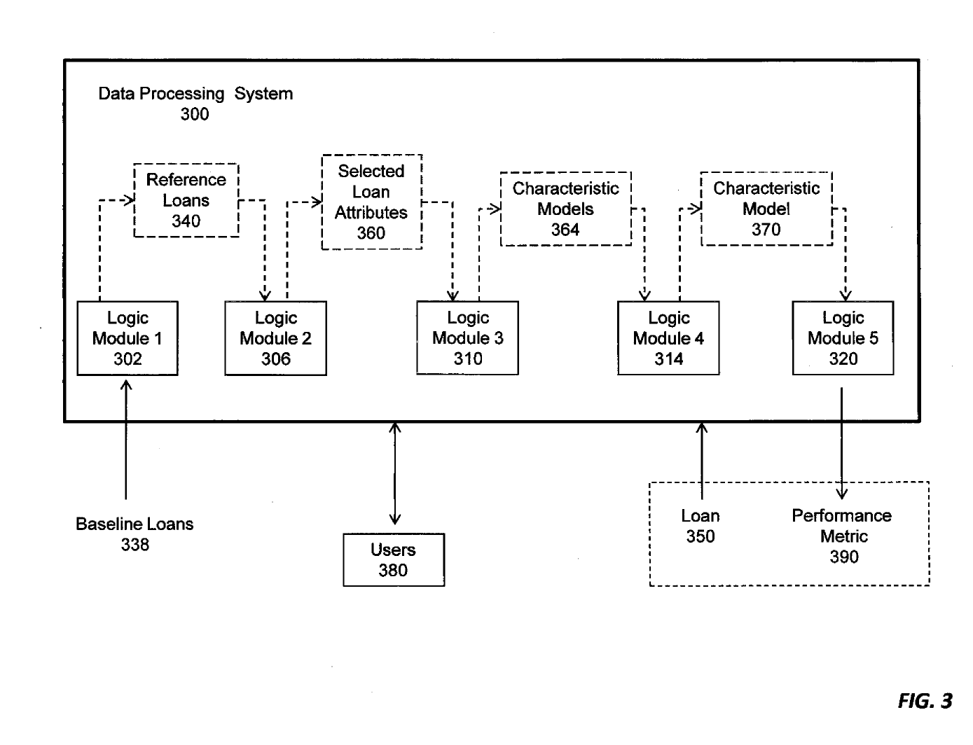

FIG. 3 shows an exemplary data processing system 300 configured to assess a performance metric of a loan under consideration in accordance with an embodiment of the present invention. The data processing system 300 is generally similar to the data processing system 200 described in connection with the embodiment of FIG. 2, but with two relatively significant differences: (1) in the embodiment of FIG. 2, logic module 3 210 computes one or more score values 264, while in the embodiment of FIG. 3, logic module 3 310 computes one or more characteristic models 364, and (2) in the embodiment of FIG. 2, logic module 4 214 computes a score value 270 for the loan 250, while in the embodiment of FIG. 3, logic module 4 314 computes a characteristic model 370 for the loan 350. In the embodiment of FIG. 3, the performance metric 390 is computed based on the characteristic model 370.

While a score value 270 represents a quantitative indicator that may be related to a performance metric 290, a characteristic model 370 is a method or process that implements an analytic framework that can facilitate computation of a particular performance metric 390. Examples of such analytic frameworks include rule-based approaches, neural networks and any other analytic or computational framework. In one embodiment, a performance metric 390 is the risk of default for a loan. In that embodiment, the characteristic model 370 could be a method or process that evaluates various conditions regarding attributes of a loan and arrives at an indicator of the likelihood of default on the loan. Logic module 5 320 could then use the result of that process to compute the performance metric 390.

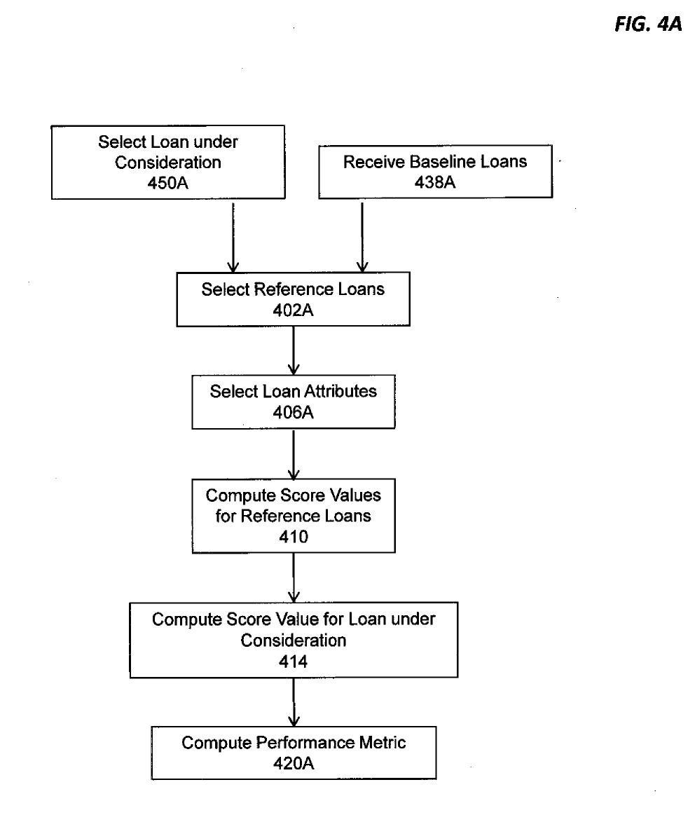

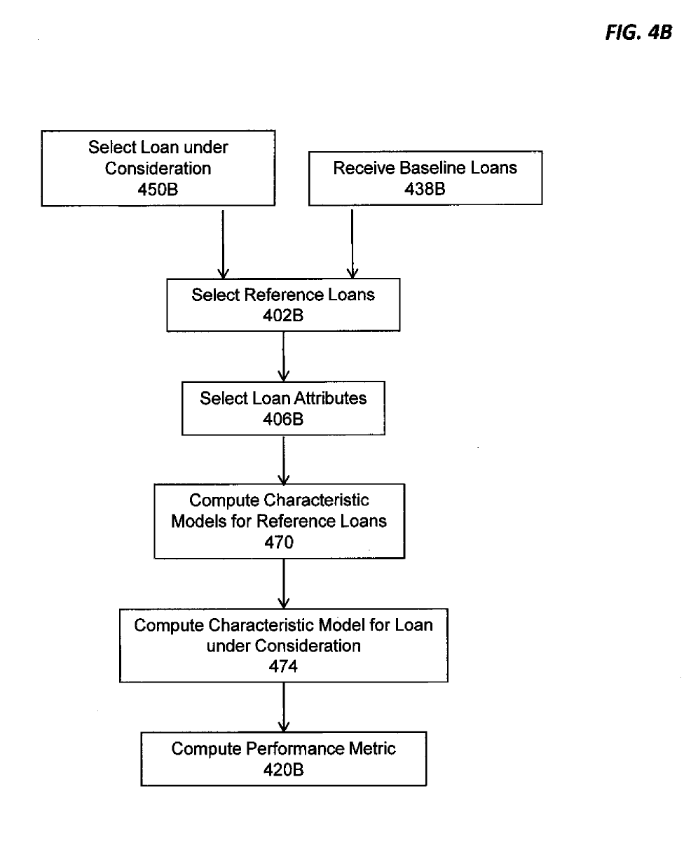

FIG. 4A shows a flowchart illustrating the operation of an exemplary data processing system configured to compute a performance metric for a loan under consideration, in accordance with an embodiment of the present invention. In one implementation, the set of steps shown in the embodiment of FIG. 4A may be performed with the data processing system 200 shown in FIG. 2, as described in more detail in connection with the embodiment of FIG. 2.

In the embodiment of FIG. 4A, the exemplary data processing system receives a set of baseline loans at step 438A. The data processing system also selects a loan under consideration at step 450A; this is the loan for which a performance metric will be computed at step 420A.

At step 402A, the exemplary data processing system selects a set of reference loans from the baseline loans received at step 438A. At step 406A, the exemplary data processing system selects a set of loan attributes for one or more of the reference loans. At step 410, the exemplary data processing system computes one or more score values for at least one of the reference loans selected at step 402A; the computation of these score values is based at least in part on one or more of the attributes selected at step 406A.

At step 414, the exemplary data processing system computes one or more score values for the loan under consideration; this computation is based at least in part on one or more of the score values computed at step 410.

At step 420A, the exemplary data processing system computes one or more performance metrics for the loan under consideration; this computation is based at least in part on at least one score value computed at step 414 for the loan under consideration.

In one implementation, one or more of the intermediate results produced in the exemplary flow chart shown in FIG. 4A are received from at least one external source, as further described in connection with the embodiment of FIG. 5. Such intermediate results may include reference loans that are selected, loan attributes that are selected, and score values that are computed for reference loans and/or for the loan under consideration.

FIG. 4B shows a flowchart illustrating the operation of an exemplary data processing system configured to compute a performance metric for a loan under consideration, in accordance with an embodiment of the present invention. The flowchart of FIG. 4B is similar to the flowchart shown in FIG. 4A, except that the computation of score values at steps 410 and 414 is replaced by the computation of characteristic models at steps 470 and respectively 474. In one implementation, only the computation of score values at 410 is replaced by the computation of characteristic models at step 470. In an alternative implementation, only the computation of score values at 414 is replaced by the computation of characteristic models at step 474.

In one implementation, the set of steps shown in the embodiment of FIG. 4B may be performed with the data processing system 300 shown in FIG. 3, as described in more detail in connection with the embodiment of FIG. 3.

In the embodiment of FIG. 4B, the exemplary data processing system receives a set of baseline loans at step 438B. The data processing system also selects a loan under consideration at step 450B; this is the loan for which a performance metric will be computed at step 420B.

At step 402B, the exemplary data processing system selects a set of reference loans from the baseline loans received at step 438B. At step 406B, the exemplary data processing system selects a set of loan attributes for one or more of the reference loans.

At step 470, the exemplary data processing system computes one or more characteristic models for at least one of the reference loans selected at step 402B; the computation of these characteristic models is based at least in part on one or more of the attributes selected at step 406B.

At step 474, the exemplary data processing system computes one or more characteristic models for the loan under consideration; this computation is based at least in part on one or more of the characteristic models computed at step 470.

At step 420B, the exemplary data processing system computes one or more performance metrics for the loan under consideration; this computation is based at least in part on at least one characteristic model computed at step 474 for the loan under consideration.

In one implementation, one or more of the intermediate results produced in the exemplary flow chart shown in FIG. 4B are received from at least one external source, as further described in connection with the embodiment of FIG. 5. Such intermediate results may include reference loans that are selected, loan attributes that are selected, and characteristic models that are computed for reference loans and/or for the loan under consideration.

A. Intermediate Results

FIG. 5 shows an exemplary data processing system 500 configured to assess a performance metric of a loan under consideration in accordance with an embodiment of the present invention. In the embodiment of FIG. 5, the data processing system 500 performs a function similar to the function performed by the embodiments shown in FIG. 2 (and respectively 4A) and FIG. 3 (and respectively 4B), except that one or more of the intermediate results computed by the logic modules included in the data processing system 200 and respectively data processing system 300 are received from at least one external source, as opposed to being directly computed. Such intermediate results may include reference loans that are selected, loan attributes that are selected, score values, and characteristic models.

In the embodiment of FIG. 5, the data processing system 500 obtains loan 510, one or more of reference loans 520, one or more of selected loan attributes 530, one or more of score values 540, and one or more of characteristic models 542 from a database 550. Database 550 is hosted by a set of storage memories. In FIG. 5, the arrow lines connecting database 550 and loan 510, reference loans 520, selected loan attributes 530, score values 540 and characteristic models 542 are dashed to emphasize that loan 510 and the intermediate results may or may not be obtained from the database 550.

In one embodiment, the score values 540 shown in the embodiment of FIG. 5 represent the score values 264 and possibly the score value 270 from the embodimentl of FIG. 2. In one embodiment, the characteristic models 542 shown in the embodiment of FIG. 5 represent the characteristic models 364 and possibly the characteristic model 370 from the embodiment of FIG. 3. For simplicity, the discussion of the embodiment in FIG. 5 will focus on score values, but this discussion would be analogously applicable to characteristic models as well.

In one implementation, external vendor 598 provides at least a subset of the reference loans 520 and at least a subset of the selected loan attributes 530 to the data processing system 500, and the data processing system 500 then computes score values 540 and the performance metric 590. In an alternative implementation, external vendor 598 provides at least a subset of the reference loans 520, at least a subset of the selected loan attributes 530 and at least a subset of the score values 540 to the data processing system 500, and the data processing system 500 then computes the performance metric 590. In one implementation, external vendor 598 provides the loan 510.

The external vendor 598 may be any company, system, service provider or other entity that can provide such intermediate results and/or the loan under consideration. In one embodiment, the external vendor 598 may be the user 580. This may happen, for example, if the user 580 is able to produce or otherwise provide any of the intermediate results, whether in addition to, or independent of the loan 510. In various embodiments, the external vendor 598 may include multiple companies, systems, service providers or other entities, each of these acting as an external vendor with respect to one or more intermediate results or with respect to the loan 510. For example, the user 580 may provide the loan 510 and the reference loans 520, an external service provider with expertise in loan processing may generate selected loan attributes 530, and another service provider may generate all other intermediate results.

In one embodiment, the score values 540 also include a score value for the loan under consideration for which the performance metric 590 will be computed. Alternatively stated, the score value 270 computed as an intermediate result in the embodiment of FIG. 2 and the characteristic model 370 computed as an intermediate result in the embodiment of FIG. 3 may also be developed by the external vendor 598 and may be provided to the data processing system 500 and/or to user 580 as part of the score values 540. This could be advantageous, for example, if the data processing system will be processing one or more loans that have already been analyzed at least in part by the external vendor 598, in which case the external vendor 598 would be able to provide at least partial intermediate results for those loans.

In one implementation, database 550 is completely included within the data processing system 500. In one implementation, database 550 is completely external to the data processing system 500, possibly stored on a storage memory attached to the data processing system 500 via a local connection (e.g., a USB or WiFi interface), or possibly stored on a storage memory coupled to the data processing system 500 via a network (e.g., a remote cloud-based memory volume). In one implementation, part of the database 550 is included within the data processing system 500, and part of the database 550 is external to the data processing system 500.

An advantage of determining in advance at least some of the reference loans 520, selected loan attributes 530, and/or score values 540 is that the architecture and operation of the data processing system 500 may be simplified by reducing the need for computing such intermediate results when computing the performance metric of the loan under consideration. Another advantage of determining such intermediate results in advance and making them available to the data processing system on demand is that at least some of the reference loans 520, selected loan attributes 530, and/or score values 540 may be determined by an external vendor and provided to the data processing system 500 and/or to one or more of the users 580 on demand. Having an external vendor develop such intermediate results independent of the operation of data processing system 500 by users 580 may ensure a higher accuracy in the models because the external vendor may have access to a broader set of loans and loan attributes, and/or may be able to develop more sophisticated and timely models for the computation of such intermediate results.

In general, external vendor 598 may determine some or all of the reference loans 520, selected loan attributes 530 and score values 540, and may make such intermediate results available to the data processing system 500. In one implementation, external vendor 598 provides to data processing system 500 and/or to user 580 at least some of the reference loans 520, selected loan attributes 530, and/or score values 540, either by storing them in database 550 or by transmitting them directly to the data processing system 500.

In one implementation, external vendor 598 manages database 550 by hosting the database 550 on a storage memory controlled by external vendor 598. In one implementation, external vendor 598 permits data processing system 500 and/or users 580 to access these intermediate results on demand from a storage memory controlled by the external vendor 598, using a login and password or another security framework. In one implementation, the external vendor 598 is hosting these intermediate results on a website or on an electronic commerce portal accessible through a communication network. In one implementation, external vendor 598 provides at least some of the reference loans 520, selected loan attributes 530, and/or score values 540 on a portable storage medium, such as a DVD or another optical medium, or on a portable storage drive (e.g., a USB flash memory drive).

In the embodiment of FIG. 5, the loan 510, the reference loans 520, the selected loan attributes 530, and/or the score values 540 may be in any data format as long as the format is recognized and can be processed by the data processing system 500 and/or by its constituent logic modules (if any). For example, some or all of the loan 510, reference loans 520, selected loan attributes 530, and/or score values 540 may be encrypted, compressed, or formatted in a data file that complies with a specific protocol (e.g., XML).

As long as such intermediate results are in a format that is recognized and can be processed by the data processing system 500 and/or by its constituent logic modules (if any), the intermediate results are construed to be adapted to be used (or to be suitable to be used) by the data processing system 500 as a basis for the assessment of the performance metric 590, regardless of whether any such intermediate result may be further processed or combined with other data. For example, a particular attribute included in the selected loan attributes 530 may be formatted using a particular meta tag that is recognized by the data processing system 500, but the data processing system may need to extract only part of the data included in that attribute (e.g., extracting the first and last name of a borrower and ignoring any middle name or initial). In general, as long as an intermediate result is made available and is usable as a basis for the assessment of the performance metric 590, such intermediate result is construed to be adapted for such use, regardless of whether the intermediate result is further processed and/or is combined with other intermediate results or other data.

In the embodiment of FIG. 5, intermediate results that are received from an external source are adapted to be used by the data processing system 500 as a basis for the assessment of the performance metric 590 of a loan under consideration.

In some implementations, at least one of the data processing systems 200, 300 or 500 may be a service hosted on a server and accessible by users remotely (e.g., in a cloud computing application), may be a software application that is installed in whole or in part on a user's personal computer, may operate in a web browser (e.g., as a Java script or Java applet), or may be any other software application or software process that runs locally or remotely relative to the user.

In some implementations, at least one of the data processing systems 200, 300 or 500 may be specific to a particular user (e.g., a software application or computer system configured to be used by a single user using specific credentials). In some implementations, at least one of the data processing systems 200, 300 or 500 may be configured to be used by a plurality of users (e.g., a customer relationship management (CRM) application that may or may not require user credentials).

### 2. Loan Portfolio Analysis

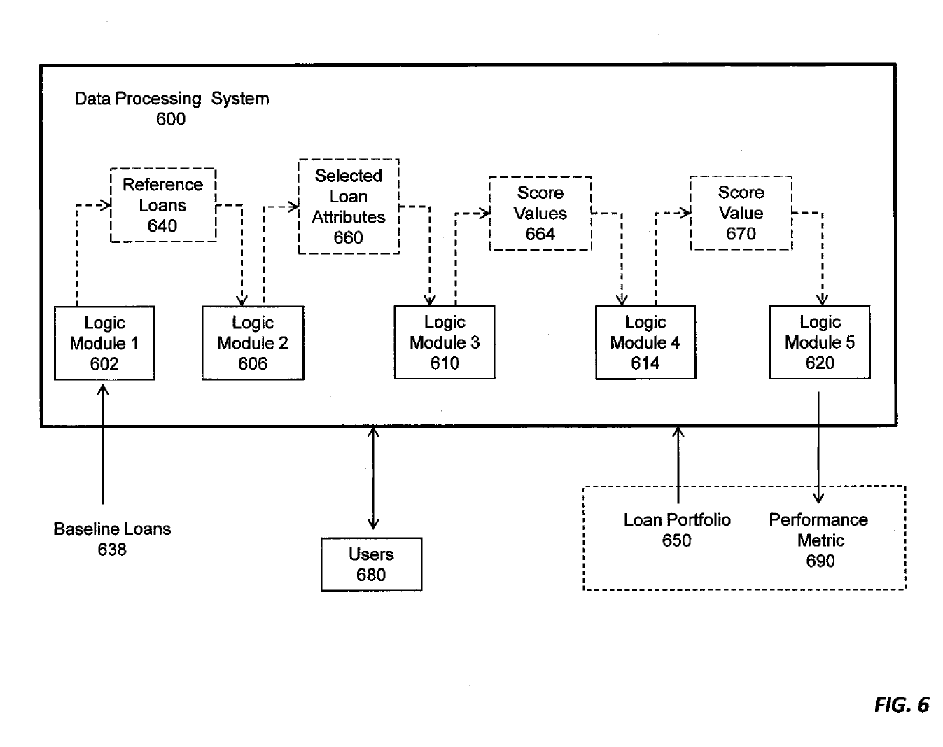

FIG. 6 shows an exemplary data processing system 600 adapted to assess a performance metric of a portfolio of loans under consideration in accordance with an embodiment of the present invention. A portfolio of loans may include one or more loans.

It is sometimes necessary or desirable to compute a performance metric for a portfolio of loans. This may be the case, for example, if a portfolio of loans under consideration cannot be feasibly subdivided into smaller segments (e.g., because all loans in the portfolio are being valued together), or if some or all of the individual component loans cannot be removed from the portfolio (e.g., a customer desires to compute a compounded performance metric for all loans but is not interested in the individual assessment of any particular loan). In this example, performance metrics would be more valuable if they pertained to the portfolio as a whole or to larger sets of loans, as opposed to individual loans.

The data processing system 600 shown in the embodiment of FIG. 6 comprises logic module 1 602, logic module 2 606, logic module 3 610, logic module 4 614 and logic module 5 620 that are configured to performed various functions in connection with the computation of a performance metric 690 for the loan portfolio under consideration, denoted loan portfolio 650.

In one embodiment, logic module 1 602 is configured to select a set of reference loans 640. Reference loans 640 may be used in connection with the assessment of performance metric 690. In one implementation, some or all of the loans included in the reference loans 640 may have been previously processed in whole or in part to extract, partition or otherwise identify specific data within such loans (e.g., for example scanning a hard copy of a loan and performing optical character recognition to identify the identity of the respective borrower). Reference loans 640 are stored in one or more storage memories (not shown in FIG. 6) that are directly or indirectly accessible by logic module 1 602. For example, logic module 1 602 may access some or all of the reference loans 640 in a storage memory included within data processing system 600, or may retrieve reference loans 640 from an external storage memory that is located in a cloud computing system via a communication network. Alternatively, some or all reference loans 640 may be transmitted to logic module 1 602 via email, via FTP, or via any other communication method that could make reference loans 640 available to logic module 1 602.

In one embodiment, logic module 1 602 selects reference loans 640 from a larger set of loans included in baseline loans 638, using specific criteria. For example, logic module 1 602 may select loans with similar attributes to the loans for which performance metrics need to be generated such as selecting loans originated, closed, or funded within similar time-frames, loans with similar types of property securing the loans, loans with similar geographic locations of borrowers, or loans with similar geographic locations of properties securing the loans, or loans with any other attributes that would help ensure that the performance metrics of the selected loans will be relevant to the performance metrics of the loans for which performance metrics need to be generated.

Baseline loans 638 are stored in one or more storage memories (not shown in FIG. 6) that are directly or indirectly accessible by logic module 1 602. For example, logic module 1 602 may access some or all of the baseline loans 638 in a storage memory included within data processing system 600, or may retrieve baseline loans 638 from an external storage memory that is located in a cloud computing system via a communication network. Alternatively, some or all baseline loans 638 may be transmitted to logic module 1 602 via email, via FTP, or via any other communication method that could make baseline loans 638 available to logic module 1 602.

In one embodiment, the reference loans 640 are made available to the logic module 2 606, either by being transmitted directly or by being stored in a storage memory that is accessible to the logic module 2 606.

In one embodiment, each of the reference loans 640 has a characteristic set of attributes. A more general discussion of loan attributes was provided above in connection with the embodiment of FIG. 2, and that discussion is incorporated here by reference.

In one embodiment, logic module 2 606 is configured to select at least one attribute of at least one of the loans included in the reference loans 640. In one implementation, logic module 2 606 may select a first set of attributes from one loan included in the reference loans 640 and may select a second set of attributes from a different loan included in the reference loans 640, where the first set and the second set of attributes may be the same, may be different, or may include some common attributes. The selected attributes are shown in the embodiment of FIG. 6 as selected loan attributes 660. For example, selected loan attributes 660 may consist of all attributes of all loans included in the reference loans 640. This may happen in a situation where the reference loans 640 do not include many attributes, or where the analysis performed is intended to maximize the data available. In another example, selected loan attributes 660 may consist of only one attribute of only one loan included in the reference loans 640. This may happen when the analysis seeks to minimize the input dataset, or where only one attribute of only one of the loans included in the reference loans 640 is considered relevant to the analysis. In general, selected loan attributes 660 may include any other number of attributes and/or reference loans, depending on the selection made by logic module 2 606. To select attributes for inclusion in the selected loan attributes 660, logic module 2 606 may take into account which attributes are expected to be available when the resulting performance metric is used, how relevant the attributes will be to the analysis, or any other criteria for selecting attributes that is appropriate for the baseline loans in question or the desired performance metric.

In one embodiment, the selected loan attributes 660 are then made available to the logic module 3 610, either by being transmitted directly or by being stored in a storage memory that is accessible to the logic module 3 610.

In one embodiment, logic module 3 610 is configured to compute one or more score values 664 for at least one of the reference loans included in the reference loans 640. In one implementation, if logic module 3 610 processes inconclusive data or otherwise encounters an inconclusive result, the logic module 3 610 may not compute any score value. This computation may be based on a subset of the attributes included in the selected loan attributes 660. In one case, score values 664 include exactly one score value for each of the reference loans included in the reference loans 640. In another case, score values 664 include more than one score value for each of the reference loans included in the reference loans 640. In another case, score values 664 do not include any score values for a subset of the reference loans included in the reference loans 640. In general, score values 664 may include zero or more score values for each of the reference loans included in the reference loans 640, but at least one of the reference loans included in the reference loans 640 will have at least one score value.

In one implementation, each of the score values included in score values 664 is a probability figure that indicates the likelihood that a relevant event will occur. For example, each of the score values included in score values 664 may indicate a probability that the corresponding loan included in the reference loans 640 may experience a default by the respective borrower. In another case, each of the score values included in score values 664 may indicate an expected amount of loss that may be incurred for the corresponding loan included in the reference loans 640. In another case, one score value included in score values 664 may indicate a probability that the corresponding loan included in the reference loans 640 may be out of compliance with one or more government requirements and a second score value included in score values 664 may indicate the expected amount of financial loss that may be incurred if the loan is out of compliance.

A more general discussion of the computation of score values was provided above in connection with the embodiment of FIG. 2, and that discussion is incorporated here by reference.

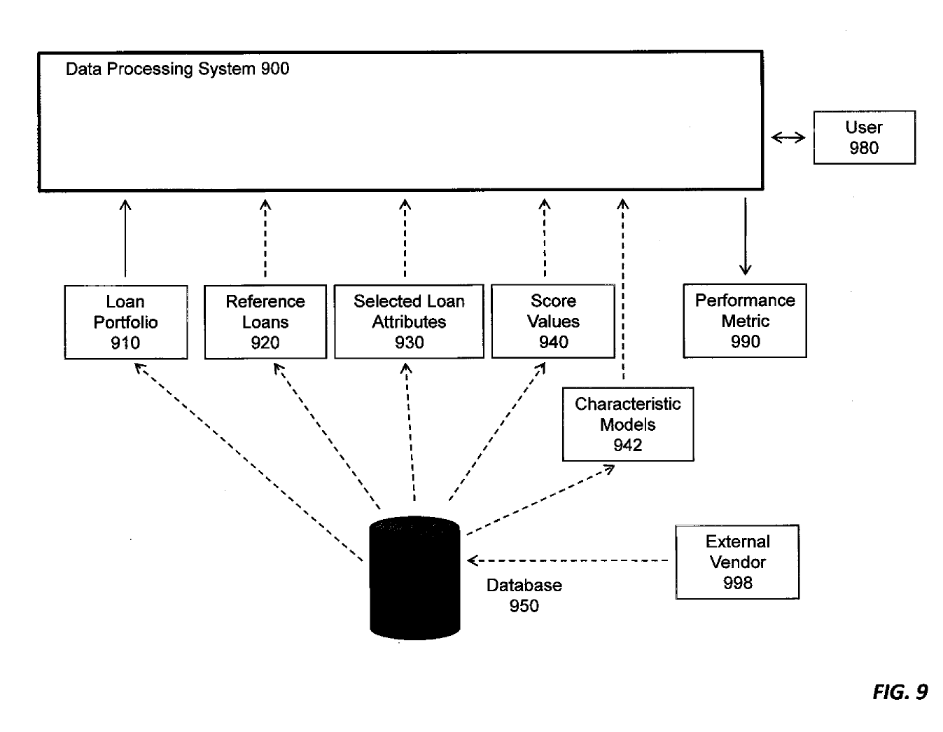

In one embodiment, the computed score values 664 are stored in a storage memory for future reference, either together with the corresponding loans included in the reference loans 240 or separately. An advantage of storing the score values 664 for future reference is that they would not have to be recomputed for subsequent analysis. Also, if the score values 664 are available in a storage memory and may be retrieved in connection with corresponding reference loans, a data processing system that computes a performance metric would be able to skip the intermediate processing required for the computation of the score values 664. FIG. 9 shows an embodiment in which score values corresponding to certain reference loans are retrieved from an external storage memory to be used by a data processing system for the computation of a performance metric. In various implementations, score values could also be received, or otherwise retrieved, from a local storage memory or from any other source.

In one embodiment, the computed score values 664 are then made available to the logic module 4 614, either by being transmitted directly or by being stored in a storage memory that is accessible to the logic module 4 614.

Logic module 4 614 is configured to compute a score value 670 that consists of one or more individual score values for the loan portfolio 650. This computation may be based on the computation of one or more of the score values 664. The score value 670 may include a probability figure that indicates the likelihood that an event relevant to loan portfolio 650 will occur, and/or a dollar amount that indicates the likely amount of financial loss associated with loan portfolio 650. Computation of the score value 670 may be made using a process analogous with the process described above for the computation of the score values 664.

In one embodiment, the score value 670 is made available to the logic module 5 620, either by being transmitted directly or by being stored in a storage memory that is accessible to the logic module 5 620. In one implementation, the score value 670 is also stored in a storage memory for future reference, either together with the loan portfolio 650 or separately. An advantage of storing the score value 670 for future reference is that it would not have to be recomputed for subsequent analysis. In one implementation, the score value 670 is stored together with the score values 664 for possible future retrieval.

In one embodiment, logic module 5 620 is configured to compute a performance metric 690 for the loan portfolio 650.

An example of performance metric 690 is the likely monetary loss due to non-compliance of at least one loan included in the loan portfolio 650 with one or more government requirements. A more general discussion of performance metrics relating to individual loans was provided above in connection with the embodiment of FIG. 2, and that discussion is incorporated here by reference. Performance metrics for a loan portfolio are generally similar to those for individual loans, but may differ from performance metrics for an individual loan in some cases. For example, a loan portfolio may be expected to diversify certain types of risks in contrast to an individual loan that could have certain expected risks due to its inherent lack of diversity, being a single loan. Performance metrics for a loan portfolio may also take into account whether certain diversities exist within a loan portfolio while performance metrics for an individual loan may not.

In one embodiment, logic module 5 620 computes the performance metric 690 based on the score value 670. The process used for the computation of the performance metric 690 may depend on the nature of the performance metric 690. A more general discussion of the computation of performance metrics for individual loans was provided above in connection with the embodiment of FIG. 2, and that discussion is incorporated here by reference.

Computation of performance metrics for a loan portfolio is generally similar to the computation of performance metrics for an individual loan, but may differ from the computation of performance metrics for an individual loan in some cases. For example, a loan portfolio may be expected to diversify certain types of risks in contrast to an individual loan that could have certain expected risks due to its inherent lack of diversity, being a single loan.

The computation of performance metrics for a loan portfolio might take into account whether certain diversities exist in a loan portfolio whereas computation of performance metrics for a single loan may not. The computation of a performance metric for the loan portfolio may perform one or more intermediate steps, such as, for example, assigning different weights to any subset of the scores of individual loans included in the loan portfolio and/or to any subset of the performance metrics of individual loans included in the loan portfolio. The computation of the performance metric for the loan portfolio could then rely on such intermediate steps to determine the performance metric for the loan portfolio in a manner substantially similar to that employed for the computation of a performance metric for an individual loan.

In the data processing system 600 described in connection with the embodiment of FIG. 6, logic module 1 602, logic module 2 606, logic module 3 610, logic module 4 614 and logic module 5 620 are independent modules and perform their respective functions independent of each other. In alternative embodiments, one or more of logic module 1 602, logic module 2 606, logic module 3 610, logic module 4 614 and logic module 5 620 may be combined in whole or in part in one or more logic module that perform all or part of the functionality of each of the respective modules. For example, logic module 1 602 and logic module 2 606 could be combined in a single logic module that is configured to perform the functionality of both logic module 1 602 and logic module 2 606, including selecting reference loans 640 and selecting selected loan attributes 660.

In the embodiment of FIG. 6, one or more human users 680 interact with the data processing system 600. Users 680 may perform various functions relating to the configuration of the data processing system 600, including programming and/or maintaining data processing system 600 or its constituent logic modules. Users 680 may also represent operators of the data processing system 600, such as an employee working for a lender and using data processing system 600 to process loans, or a government employee using data processing system 600 to verify loan compliance.

In one implementation, at least one of the users 680 accesses data processing system 600 directly via a human input device (e.g., a keyboard). This may happen, for example, when data processing system 600 is a desktop computer and a user is operating the desktop computer directly. In another implementation, at least one of the users 680 accesses data processing system 600 via a communication network. This may happen, for example, when data processing system 600 is a server computer or a service operating in a cloud system, and a user is logging into the server or cloud system remotely.

The access of users 680 to data processing system 600 may be regulated using a security clearance model based on credentials of specific human users 680. For example, a more limited credential profile for a non-managerial employee could permit the respective human user to only access specific functions of the data processing system 600 or to only process specific loans. Such a security clearance model could be implemented using a login (e.g., username and password) validation model.

Users 680 may also access data processing system 600 indirectly via one or more separate portals or systems, interacting directly or indirectly with data processing system 600.

The performance metric 690 and all other data produced and/or output by data processing system 600 may be formatted in any file format or using any data format protocol, and may be displayed on a screen, exported, downloaded, emailed or otherwise made available to the respective users 680.

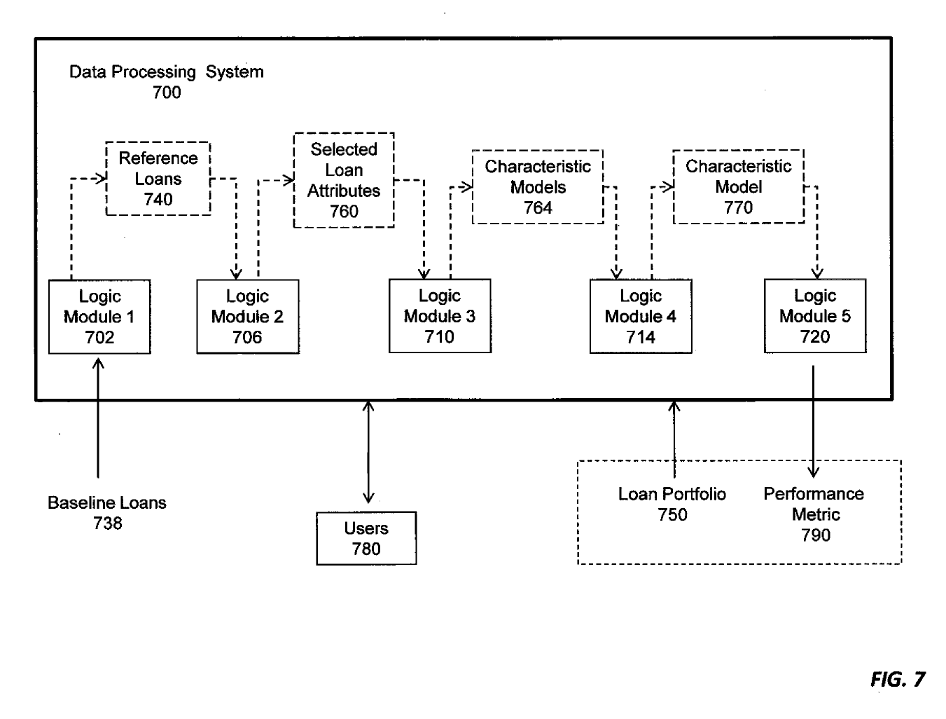

FIG. 7 shows an exemplary data processing system 700 adapted to assess a performance metric of a portfolio of loans under consideration in accordance with an embodiment of the present invention. The data processing system 700 is generally similar to the data processing system 600 described in connection with the embodiment of FIG. 6, but with two relatively significant differences: (1) in the embodiment of FIG. 6, logic module 3 610 computes one or more score values 664, while in the embodiment of FIG. 7, logic module 3 710 computes one or more characteristic models 764, and (2) in the embodiment of FIG. 6, logic module 4 614 computes a score value 670 for the loan portfolio 650, while in the embodiment of FIG. 7, logic module 4 714 computes a characteristic model 770 for the loan portfolio 750. In the embodiment of FIG. 7, the performance metric 790 is computed based on the characteristic model 770.

While a score value 670 represents a quantitative indicator that may be related to a performance metric 690, a characteristic model 770 is a method or process that implements an analytic framework that can facilitate computation of a particular performance metric 790. Examples of such analytic frameworks include rule-based approaches, neural networks and any other analytic or computational framework. In one embodiment, a performance metric 790 is the risk of default for a loan portfolio. A more general discussion of characteristic models for individual loans was provided above in connection with the embodiment of FIG. 3, and that discussion is incorporated here by reference.

Computation of characteristic models for a loan portfolio is generally similar to the computation of characteristic models for an individual loan, but may differ from computation of characteristic models for an individual loan in certain cases. For example, a loan portfolio may be expected to diversify certain types of risks in contrast to an individual loan that could have certain expected risks due to its inherent lack of diversity, being a single loan.

The computation of performance metrics for a loan portfolio might take into account whether certain diversities exist in a loan portfolio whereas computation of performance metrics for a single loan may not. The computation of a performance metric for the loan portfolio may perform one or more intermediate steps, such as, for example, assigning different weights to any subset of the scores of individual loans included in the loan portfolio and/or to any subset of the performance metrics of individual loans included in the loan portfolio. The computation of the performance metric for the loan portfolio could then rely on such intermediate steps to determine the performance metric for the loan portfolio in a manner substantially similar to that employed for the computation of a performance metric for an individual loan.

In the embodiment of FIG. 7, logic module 5 720 uses the characteristic model 770 to compute the performance metric 790.

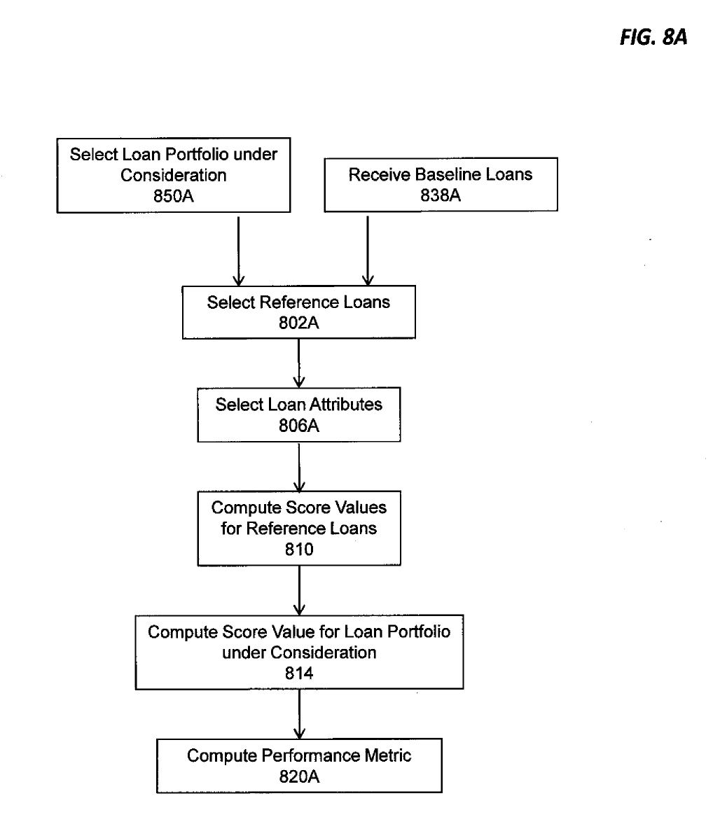

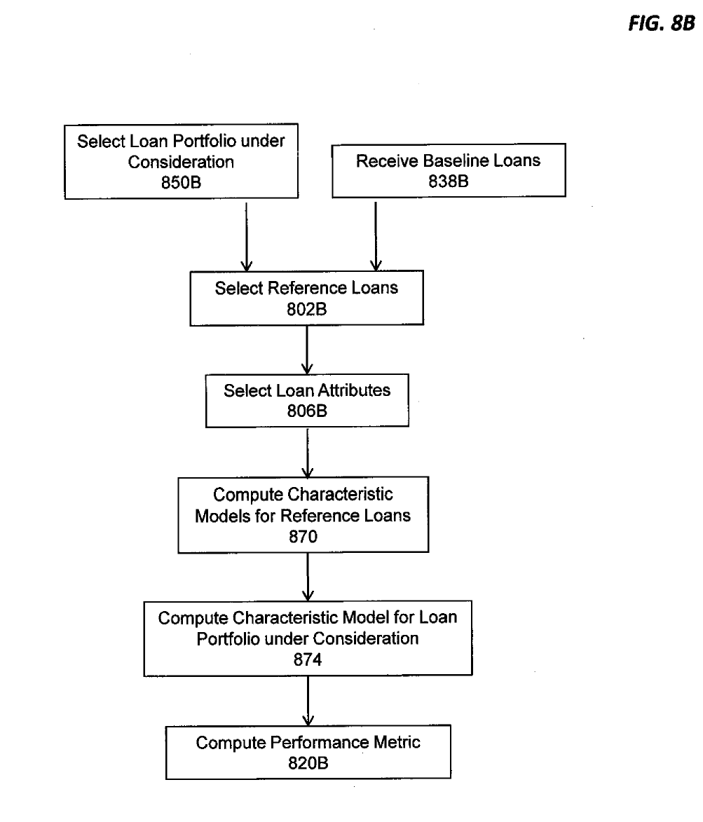

FIG. 8A shows a flowchart illustrating the operation of an exemplary data processing system configured to compute a performance metric for a loan portfolio under consideration in accordance with an embodiment of the present invention. In one implementation, the set of steps shown in the embodiment of FIG. 8A may be performed with the data processing system 600 shown in FIG. 6, as described in more detail in connection with the embodiment of FIG. 6.

In the embodiment of FIG. 8A, the exemplary data processing system receives a set of baseline loans at step 838A. The data processing system also selects a loan portfolio under consideration at step 850A; this is the loan portfolio for which a performance metric will be computed at step 820A.

At step 802A, the exemplary data processing system selects a set of reference loans from the baseline loans received at step 838A. At step 806A, the exemplary data processing system selects a set of loan attributes for one or more of the reference loans. At step 810, the exemplary data processing system computes one or more score values for at least one of the reference loans selected at step 802A; the computation of these score values is based at least in part on one or more of the attributes selected at step 806A.

At step 814, the exemplary data processing system computes one or more score values for the loan portfolio under consideration; this computation is based at least in part on one or more of the score values computed at step 810.

At step 820A, the exemplary data processing system computes one or more performance metrics for the loan portfolio under consideration; this computation is based at least in part on at least one score value computed at step 814 for the loan portfolio under consideration.

In one implementation, one or more of the intermediate results produced in the exemplary flow chart shown in FIG. 8A are received from at least one external source, as further described in connection with the embodiment of FIG. 9. Such intermediate results may include reference loans that are selected, loan attributes that are selected, and the score values that are computed for reference loans and/or for the loan portfolio under consideration.

FIG. 8B shows a flowchart illustrating the operation of an exemplary data processing system configured to compute a performance metric for a loan portfolio under consideration in accordance with an embodiment of the present invention. The flowchart of FIG. 8B is similar to the flowchart shown in FIG. 8A, except that the computation of score values at steps 810 and 814 is replaced by the computation of characteristic models at steps 870 and respectively 874. In one implementation, only the computation of score values at 810 is replaced by the computation of characteristic models at step 870. In an alternative implementation, only the computation of score values at 814 is replaced by the computation of characteristic models at step 874.

In one implementation, the set of steps shown in the embodiment of FIG. 8B may be performed with the data processing system 700 shown in FIG. 7, as described in more detail in connection with the embodiment of FIG. 7.

In the embodiment of FIG. 8B, the exemplary data processing system receives a set of baseline loans at step 838B. The data processing system also selects a loan portfolio under consideration at step 850B; this is the loan portfolio for which a performance metric will be computed at step 820B.

At step 802B, the exemplary data processing system selects a set of reference loans from the baseline loans received at step 838B. At step 806B, the exemplary data processing system selects a set of loan attributes for one or more of the reference loans.

At step 870, the exemplary data processing system computes one or more characteristic models for at least one of the reference loans selected at step 802B; the computation of these characteristic models is based at least in part on one or more of the attributes selected at step 806B.

At step 874, the exemplary data processing system computes one or more characteristic models for the loan portfolio under consideration; this computation is based at least in part on one or more of the characteristic models computed at step 870.

At step 820B, the exemplary data processing system computes one or more performance metrics for the loan portfolio under consideration; this computation is based at least in part on at least one characteristic model computed at step 874 for the loan portfolio under consideration.

In one implementation, one or more of the intermediate results produced in the exemplary flow chart shown in FIG. 8B are received from at least one external source, as further described in connection with the embodiment of FIG. 9. Such intermediate results may include reference loans that are selected, loan attributes that are selected, and characteristic models that are computed for reference loans and/or for the loan portfolio under consideration.

A. Intermediate Results

FIG. 9 shows an exemplary data processing system 900 adapted to assess a performance metric of a loan portfolio under consideration in accordance with an embodiment of the present invention. In the embodiment of FIG. 9, the data processing system 900 performs a function similar to the function performed by the embodiments shown in FIG. 6 (and respectively 8A) and FIG. 7 (and respectively 8B), except that one or more of the intermediate results computed by the logic modules included in the data processing system 600 and respectively data processing system 700 are received from at least one external source, as opposed to being directly computed. Such intermediate results include reference loans that are selected, loan attributes that are selected, and computed score values and characteristic models.

In the embodiment of FIG. 9, the data processing system 900 obtains loan portfolio 910, one or more of reference loans 920, one or more of selected loan attributes 930, one or more of score values 940 and/or one or more of characteristic models 942 from a database 950. Database 950 is hosted by a set of storage memories. In FIG. 9, the arrow lines connecting database 950 and loan portfolio 910, reference loans 920, selected loan attributes 930, score values 940 and characteristic models 942 are dashed to emphasize that loan portfolio 910 and the intermediate results may or may not be obtained from the database 950.

In one embodiment, the score values 940 shown in the embodiment of FIG. 9 represent the score values 664 and possibly the score value 670 from the embodiment of FIG. 6. In one embodiment, the characteristic models 942 shown in the embodiment of FIG. 9 represent the characteristic models 764 and possibly the characteristic model 770 from the embodiment of FIG. 7. For simplicity, the discussion of the embodiment in FIG. 9 will focus on score values, but this discussion would be analogously applicable to characteristic models as well.

In one implementation, external vendor 998 provides at least a subset of the reference loans 920 and at least a subset of the selected loan attributes 930 to the data processing system 900, and the data processing system 900 then computes score values 940 and the performance metric 990. In an alternative implementation, external vendor 998 provides at least a subset of the reference loans 920, at least a subset of the selected loan attributes 930 and at least a subset of the score values 940 to the data processing system 900, and the data processing system 900 then computes the performance metric 990. In one implementation, external vendor 998 provides the loan portfolio 910.

In one embodiment, the score values 940 also include a score value for the loan under consideration for which the performance metric 990 will be computed. Alternatively stated, the score value 670 computed as an intermediate result in the embodiment of FIG. 6 and the characteristic model 770 computed as an intermediate result in the embodiment of FIG. 7 may also be developed by the external vendor 998 and may be provided to the data processing system 900 and/or to user 980 as part of the score values 940. This could be advantageous, for example, if the data processing system will be processing one or more loans that have already been analyzed at least in part by the external vendor 998, in which case the external vendor 998 would be able to provide at least partial intermediate results for those loans.

The external vendor 998 may be any company, system, service provider or other entity that can provide such intermediate results and/or the loan under consideration. In one embodiment, the external vendor 998 may be the user 980. This may happen, for example, if the user 980 is able to produce or otherwise provide any of the intermediate results, whether in addition to, or independent of the loan portfolio 910. In various embodiments, the external vendor 998 may include multiple companies, systems, service providers or other entities, each of these acting as an external vendor with respect to one or more intermediate results or with respect to the loan portfolio 910. For example, the user 980 may provide the loan portfolio 910 and the reference loans 920, an external service provider with expertise in loan processing may generate selected loan attributes 930, and another service provider may generate all other intermediate results.

In one implementation, database 950 is completely included within the data processing system 900. In one implementation, database 950 is completely external to the data processing system 900, possibly stored on a storage memory attached to the data processing system 900 via a local connection (e.g., a USB or WiFi interface), or possibly stored on a storage memory coupled to the data processing system 900 via a network (e.g., a remote cloud-based memory volume). In one implementation, part of the database 950 is included within the data processing system 900, and part of the database 950 is external to the data processing system 900.

An advantage of determining in advance at least some of the reference loans 920, selected loan attributes 930, and/or score values 940 is that the architecture and operation of the data processing system 900 may be simplified by reducing the need for computing such intermediate results when computing the performance metric of the loan under consideration. Another advantage of determining such intermediate results in advance and making them available to the data processing system on demand is that at least some of the reference loans 920, selected loan attributes 930, and/or score values 940 may be determined by an external vendor and provided to the data processing system 900 and/or to one or more of the users 980 on demand. Having an external vendor develop such intermediate results independent of the operation of data processing system 900 by users 980 may ensure a higher accuracy in the models because the external vendor may have access to a broader set of loans and loan attributes, and/or may be able to develop more sophisticated and timely models for the computation of such intermediate results.

In general, external vendor 998 may determine some or all of the reference loans 920, selected loan attributes 930 and score values 940, and may make such intermediate results available to the data processing system 900. In one implementation, external vendor 998 provides to data processing system 900 and/or to user 980 at least some of the reference loans 920, selected loan attributes 930, and/or score values 940, either by storing them in database 950 or by transmitting them directly to the data processing system 900.

In one implementation, external vendor 998 manages database 950 by hosting the database 950 on a storage memory controlled by external vendor 998. In one implementation, external vendor 998 permits data processing system 900 and/or users 980 to access these intermediate results on demand from a storage memory controlled by the external vendor 998, using a login and password or another security framework. In one implementation, the external vendor 998 is hosting these intermediate results on a website or on an electronic commerce portal accessible through a communication network. In one implementation, external vendor 998 provides at least some of the reference loans 920, selected loan attributes 930, and/or score values 940 on a portable storage medium, such as a DVD or another optical medium, or on a portable storage drive (e.g., a USB flash memory drive).

In the embodiment of FIG. 9, the loan 910, the reference loans 920, the selected loan attributes 930, and/or the score values 940 may be in any data format as long as the format is recognized and can be processed by the data processing system 900 and/or by its constituent logic modules (if any). For example, some or all of the loan 910, reference loans 920, selected loan attributes 930, and/or score values 940 may be encrypted, compressed, or formatted in a data file that complies with a specific protocol (e.g., XML).

As long as such intermediate results are in a format that is recognized and can be processed by the data processing system 900 and/or by its constituent logic modules (if any), the intermediate results are construed to be adapted to be used by the data processing system 900 as a basis for the assessment of the performance metric 990, regardless of whether any such intermediate result may be further processed or combined with other data. For example, a particular attribute included in the selected loan attributes 930 may be formatted using a particular meta tag that is recognized by the data processing system 900, but the data processing system may need to extract only part of the data included in that attribute (e.g., extracting the first and last name of a borrower and ignoring any middle name or initial). In general, as long as an intermediate result is made available and is usable as a basis for the assessment of the performance metric 990, such intermediate result is construed to be adapted for such use, regardless of whether the intermediate result is further processed and/or is combined with other intermediate results or other data.

In some implementations, at least one of the data processing systems 600, 700 or 900 may be a service hosted on a server and accessible by users remotely (e.g., in a cloud computing application), may be a software application that is installed in whole or in part on a user's personal computer, may operate in a web browser (e.g., as a Java script or Java applet), or may be any other software application or software process that runs locally or remotely relative to the user.

In some implementations, at least one of the data processing systems 600, 700 or 900 may be specific to a particular user (e.g., a software application or computer system configured to be used by a single user using specific credentials). In some implementations, at least one of the data processing systems 600, 700 or 900 may be configured to be used by a plurality of users (e.g., a customer relationship management (CRM) application that may or may not require user credentials).

3. Financial Entity Analysis

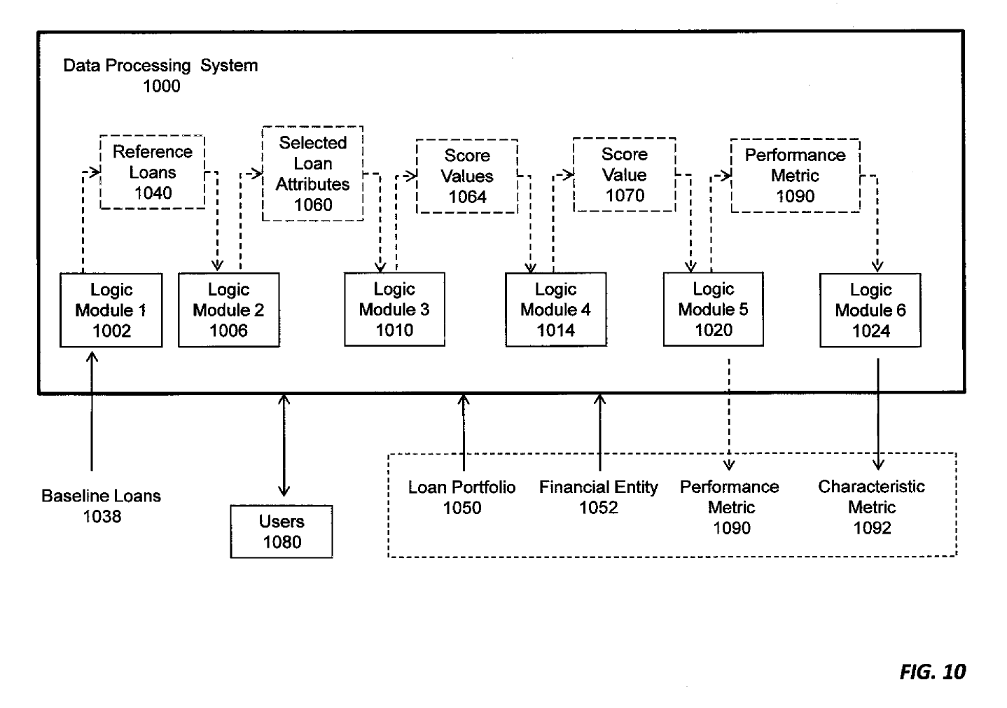

FIG. 10 shows an exemplary data processing system 1000 adapted to assess a characteristic metric of a financial entity based on a portfolio of loans under consideration in accordance with an embodiment of the present invention.

For purposes of various embodiments described in this patent, a financial entity is any financial institution such as a bank, broker, credit union, savings and loan association, savings association, entity that provides interim financing (e.g., a warehouse bank), mortgage banker, entity involved in the origination, processing, underwriting, closing, funding, or any loan-related processes, investment bank, hedge fund, loan buyer, security buyer, security owner, security broker, insurer of securities (e.g., an entity that offers pool insurance, an entity that insures its own securities, etc.), insurer of loans (e.g. an entity that offers loan-related insurance), a loan guarantor, (e.g., the United States Federal Deposit Insurance Corporation or any other United States or foreign government or governmental agency), or any other individual or private, administrative, governmental or commercial entity that is able to hold a financial instrument related to a portfolio of loans (e.g., a company, partnership or other legal entity, a hedge fund, etc.).

For purposes of various embodiments described in this patent, a financial instrument includes any security or other financial interest, including debt securities (e.g., banknotes, bonds and debentures), equity securities (e.g., common stock, derivative contracts, forwards, futures, options and swaps), mortgage-backed securities (e.g., a financial interest that is backed by, or otherwise relates to a mortgage), loan servicing rights, insurance or other similar contracts related to a loan, and any other instruments representing financial value in any type of underlying tangible or intangible collateral, whether or not registered with a governmental entity.

For purposes of various embodiments described in this patent, a financial entity may also denote any individual affiliated with one or more loans that are associated with a financial entity, including any individual that is involved in the process of originating, processing, underwriting, conducting quality control, reviewing compliance, closing, funding, insuring, servicing, buying, or selling loans for a financial entity, individual loan broker, group of people working for a financial entity (e.g., a department within a financial entity), or some other logical administrative or operational unit associated with a financial entity (e.g., a loan servicer or loan processing entity that services a loan or collects loan payments, etc.).

For purposes of various embodiments described in this patent, a financial instrument may be construed to be associated with a particular loan when the financial instrument is at least partially secured or otherwise backed by that loan, or if the value of the financial instrument is otherwise directly or indirectly dependent on that loan.

For purposes of various embodiments described in this patent, a financial entity may be construed to be associated with a portfolio of loans when the financial entity holds a financial interest in one or more loans included in that portfolio of loans, or if the financial entity has otherwise processed, evaluated, rated, analyzed, or been involved in any part of any process or transaction involving one or more loans included in that portfolio of loans. For example, a financial entity may have originated, held, funded, insured, invested in, or otherwise held any ownership stake or other interest (e.g., a contractual rights or an option) in one or more loans included in that portfolio of loans.

For purposes of various embodiments described in this patent, a financial instrument may be construed to be associated with a portfolio of loans when the financial instrument is at least partially secured or otherwise backed by at least one loan included in that portfolio of loans, or if the value of the financial instrument is otherwise directly or indirectly dependent on at least one loan included in that portfolio of loans.

It may sometimes be advantageous to assess one or more loan-related characteristic metrics for a financial entity associated with a portfolio of loans. In one example, the viability of a first financial entity may be directly or indirectly related to the success or failure of transactions involving a portfolio of loans that the first financial entity is or has been associated with and a second financial entity may wish to assess one or more loan-related characteristic metrics for the first financial entity in order to rate the first financial entity according to risks that may be associated with engaging in a business relationship with the second financial entity. In another example a government entity may seek to allocate enforcement resources to a regulated financial entity associated with a portfolio of loans by assessing various loan-related characteristic metrics for the regulated financial entity under consideration so as to rank the entity on a scale from those meriting a higher level of supervision or enforcement to those meriting a lower level of supervision or enforcement. In yet another example, assessing one or more loan-related characteristic metrics for a financial entity associated with a portfolio of loans may serve as the basis to compute a rating (e.g. investment-grade, speculative, junk), a monetary estimate of gain or loss of associating with the financial entity, or any other metric that is related to the financial entity.

An example of a characteristic metric of a financial entity associated with a portfolio of loans is a rating of the financial entity. An example of a rating would be the likelihood that the financial entity is associated with one or more loans in default that are included in the respective portfolio of loans. Another example of a rating would be the likelihood that the financial entity is associated with one or more noncompliant loans that are included in the respective portfolio of loans. Another example of a rating would be the likelihood that the financial entity is associated with one or more fraudulent loans that are included in the respective portfolio of loans.

Another example of a characteristic metric of a financial entity associated with a portfolio of loans is the expected financial performance of the financial entity based on the financial entity's association with the portfolio of loans. Examples of such expected financial performance would include expected financial loss or expected financial gain derived from one or more of the loans included in the portfolio of loans.

Another example of a characteristic metric of a financial entity associated with a portfolio of loans is a risk score for the financial entity based on the financial entity's association with the portfolio of loans. An example of such a risk score is a numeric indicator where higher numbers indicate a higher relative level of risk to other entities that may be associated with the financial entity under consideration (e.g. borrowers, business affiliates, insurers, guarantors, investors, etc.).

The data processing system 1000 shown in the embodiment of FIG. 10 comprises logic module 1 1002, logic module 2 1006, logic module 3 1010, logic module 4 1014, logic module 5 1020 and logic module 6 1024 that are configured to performed various functions in connection with the computation of a performance metric 1090 for the loan portfolio under consideration, denoted loan portfolio 1050, and a characteristic metric 1092 for a financial entity 1052 associated with the loan portfolio 1050.

In one embodiment, logic module 1 1002 is configured to select a set of reference loans 1040. Reference loans 1040 may be used in connection with the assessment of performance metric 1090. In one implementation, some or all of the loans included in the reference loans 1040 may have been previously processed in whole or in part to extract, partition or otherwise identify specific data within such loans (e.g., for example scanning a hard copy of a loan and performing optical character recognition to identify the identity of the respective borrower). Reference loans 1040 are stored in one or more storage memories (not shown in FIG. 10) that are directly or indirectly accessible by logic module 1 1002. For example, logic module 1 1002 may access some or all of the reference loans 1040 in a storage memory included within data processing system 1000, or may retrieve reference loans 1040 from an external storage memory that is located in a cloud computing system via a communication network. Alternatively, some or all reference loans 1040 may be transmitted to logic module 1 1002 via email, via FTP, or via any other communication method that could make reference loans 1040 available to logic module 1 1002.

In one embodiment, logic module 1 1002 selects reference loans 1040 from a larger set of loans included in baseline loans 1038, using specific criteria. For example, logic module 1 1002 may select loans with similar attributes to the loans for which performance metrics need to be generated such as selecting loans originated, closed, or funded within similar time-frames, loans with similar types of property securing the loans, loans with similar geographic locations of borrowers, or loans with similar geographic locations of properties securing the loans, or loans with any other attributes that would help ensure that the performance metrics of the selected loans will be relevant to the performance metrics of the loans for which performance metrics need to be generated.

Baseline loans 1038 are stored in one or more storage memories (not shown in FIG. 10) that are directly or indirectly accessible by logic module 1 1002. For example, logic module 1 1002 may access some or all of the baseline loans 1038 in a storage memory included within data processing system 1000, or may retrieve baseline loans 1038 from an external storage memory that is located in a cloud computing system via a communication network. Alternatively, some or all baseline loans 1038 may be transmitted to logic module 1 1002 via email, via FTP, or via any other communication method that could make baseline loans 1038 available to logic module 1 1002.

In one embodiment, the reference loans 1040 are made available to the logic module 2 1006, either by being transmitted directly or by being stored in a storage memory that is accessible to the logic module 2 1006.

In one embodiment, each of the logic module 1 1002 has a characteristic set of attributes. A more general discussion of loan attributes was provided above in connection with the embodiment of FIG. 2, and that discussion is incorporated here by reference.

In one embodiment, logic module 2 1006 is configured to select at least one attribute of at least one of the loans included in the reference loans 1040. In one implementation, logic module 2 1006 may select a first set of attributes from one loan included in the reference loans 1040 and may select a second set of attributes from a different loan included in the reference loans 1040, where the first set and the second set of attributes may be the same, may be different, or may include some common attributes. The selected attributes are shown in the embodiment of FIG. 10 as selected loan attributes 1060. For example, selected loan attributes 1060 may consist of all attributes of all loans included in the reference loans 1040. This may happen in a situation where the reference loans 1040 do not include many attributes, or where the analysis performed is intended to maximize the data available. In another example, selected loan attributes 1060 may consist of only one attribute of only one loan included in the reference loans 1040. This may happen when the analysis seeks to minimize the input dataset, or where only one attribute of only one of the loans included in the reference loans 1040 is considered relevant to the analysis. In general, selected loan attributes 1060 may include any other number of attributes and/or reference loans, depending on the selection made by logic module 2 1006. To select attributes for inclusion in the selected loan attributes 1060, logic module 2 1006 may take into account which attributes are expected to be available when the resulting performance metric is used, how relevant the attributes will be to the analysis, or any other criteria for selecting attributes that is appropriate for the baseline loans in question or the desired performance metric.

In one embodiment, the selected loan attributes 1060 are then made available to the logic module 3 1010, either by being transmitted directly or by being stored in a storage memory that is accessible to the logic module 3 1010.

In one embodiment, logic module 3 1010 is configured to compute one or more score values 1064 for at least one of the reference loans included in the reference loans 1040. In one implementation, if logic module 3 1010 processes inconclusive data or otherwise encounters an inconclusive result, the logic module 3 1010 may not compute any score value. This computation may be based on a subset of the attributes included in the selected loan attributes 1060. In one case, score values 1064 include exactly one score value for each of the reference loans included in the reference loans 1040. In another case, score values 1064 include more than one score value for each of the reference loans included in the reference loans 1040. In another case, score values 1064 do not include any score values for a subset of the reference loans included in the reference loans 1040. In general, score values 1064 may include zero or more score values for each of the reference loans included in the reference loans 1040, but at least one of the reference loans included in the reference loans 1040 will have at least one score value.

In one implementation, each of the score values included in score values 1064 is a probability figure that indicates the likelihood that a relevant event will occur. For example, each of the score values included in score values 1064 may indicate a probability that the corresponding loan included in the reference loans 1040 may experience a default by the respective borrower. In another case, each of the score values included in score values 1064 may indicate an expected amount of loss that may be incurred for the corresponding loan included in the reference loans 1040. In another case, one score value included in score values 1064 may indicate a probability that the corresponding loan included in the reference loans 1040 may be out of compliance with one or more government requirements and a second score value included in score values 1064 may indicate the expected amount of financial loss that may be incurred if the loan is out of compliance.

A more general discussion of the computation of score values was provided above in connection with the embodiment of FIG. 2, and that discussion is incorporated here by reference.

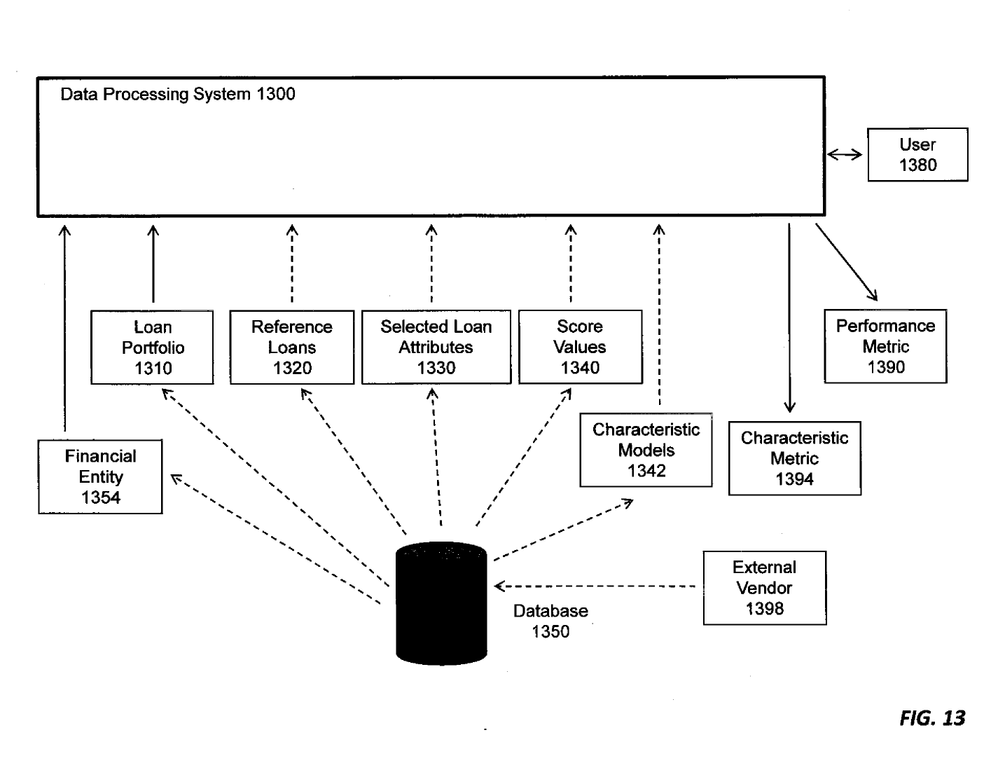

In one embodiment, the computed score values 1064 are stored in a storage memory for future reference, either together with the corresponding loans included in the reference loans 1040 or separately. An advantage of storing the score values 1064 for future reference is that they would not have to be recomputed for subsequent analysis. Also, if the score values 1064 are available in a storage memory and may be retrieved in connection with corresponding reference loans, a data processing system that computes a performance metric would be able to skip the intermediate processing required for the computation of the score values 1064. FIG. 13 shows an embodiment in which score values corresponding to certain reference loans are retrieved from an external storage memory to be used by a data processing system for the computation of a performance metric. In various implementations, score values could also be received, or otherwise retrieved, from a local storage memory or from any other source.

In one embodiment, the computed score values 1064 are then made available to the logic module 4 1014, either by being transmitted directly or by being stored in a storage memory that is accessible to the logic module 4 1014.

Logic module 4 1014 is configured to compute a score value 1070 that consists of one or more individual score values for the loan portfolio 1050. This computation may be based on the computation of one or more of the score values 1064. The score value 1070 may include a probability figure that indicates the likelihood that an event relevant to loan portfolio 1050 will occur, and/or a dollar amount that indicates the likely amount of financial loss associated with loan portfolio 1050. Computation of the score value 1070 may be made using a process analogous with the process described above for the computation of the score values 1064.

In one embodiment, the score value 1070 is made available to the logic module 5 1020, either by being transmitted directly or by being stored in a storage memory that is accessible to the logic module 5 1020. In one implementation, the score value 1070 is also stored in a storage memory for future reference, either together with the loan portfolio 1050 or separately. An advantage of storing the score value 1070 for future reference is that it would not have to be recomputed for subsequent analysis. In one implementation, the score value 1070 is stored together with the score values 1064 for possible future retrieval.

In one embodiment, logic module 5 1020 is configured to compute a performance metric 1090 for the loan portfolio 1050.

An example of performance metric 1090 is the risk of default of at least one loan included in the loan portfolio 1050. A more general discussion of performance metrics for a loan portfolio was provided above in connection with the embodiments of FIG. 2 and FIG. 6, and that discussion is incorporated here by reference.

In one embodiment, logic module 5 1020 computes the performance metric 1090 based on the score value 1070. The process used for the computation of the performance metric 1090 may depend on the nature of the performance metric 1090. A more general discussion of the computation of performance metrics was provided above in connection with the embodiments of FIG. 2 and FIG. 6, and that discussion is incorporated here by reference.

In one embodiment, the performance metric 1090 is made available to the logic module 6 1024, either by being transmitted directly or by being stored in a storage memory that is accessible to the logic module 6 1024. In one implementation, the performance metric 1090 is also stored in a storage memory for future reference, either together with the loan portfolio 1050 or separately. An advantage of storing the score value 1070 for future reference is that it would not have to be recomputed for subsequent analysis. In one implementation, the score value 1070 is stored together with the score values 1064 for possible future retrieval.

In one embodiment, logic module 6 1024 is configured to compute a characteristic metric 1092 for the financial entity 1052. In one implementation, the data processing system 1000 retrieves or otherwise receives information identifying the financial entity 1052, including possibly a name, an address, an identification number, and/or other data relating to the financial entity 1052.

An example of a characteristic metric of a financial entity associated with a portfolio of loans is a rating of the financial entity. Characteristic metrics were discussed in more detail above in connection with the embodiment shown in FIG. 10.

In one embodiment, logic module 6 1024 computes the characteristic metric 1092 based on the performance metric 1090. The process used for the computation of the characteristic metric 1092 may depend on the nature of the characteristic metric 1092 and/or the performance metric 1090.

Computation of a characteristic metric for a financial entity under consideration may be achieved in one embodiment by using a computed performance metric that relates to a loan portfolio that the financial entity is associated with, determining the extent to which the loan portfolio could have a material impact on the financial entity based on how the financial entity is related to the loan portfolio, and adjusting, scaling or otherwise incorporating, in whole or in part, the computed performance metric for the loan portfolio to arrive at a computed characteristic metric for the financial entity. In one example, a financial entity may have a limited exposure to expected financial losses in a loan portfolio with which it is associated because it only owns a 10% stake in the loan portfolio. In this example, the characteristic metric may be computed by taking the computed performance metric for the loan portfolio with which the financial entity is associated and adjusting it in the course of computing the characteristic metric for the financial entity in order to reflect the limited stake that the financial entity has in the loan portfolio.

In one embodiment, the performance metric 1090 is an intermediate result that is used in the course of the computation of the characteristic metric 1092, and then it is output by the data processing system 1000 and/or is stored for further future use. In another embodiment, the performance metric 1090 is an intermediate result that is used in the course of the computation of the characteristic metric 1092, but is not output by the data processing system 1000 and is not stored for further use.

In the data processing system 1000 described in connection with the embodiment of FIG. 10 logic module 1 1002, logic module 2 1006, logic module 3 1010, logic module 4 1014, logic module 5 1020 and logic module 6 1024 are independent modules and perform their respective functions independent of each other. In alternative embodiments, one or more of logic module 1 1002, logic module 2 1006, logic module 3 1010, logic module 4 1014, logic module 5 1020 and logic module 6 1024 may be combined in whole or in part in one or more logic module that perform all or part of the functionality of each of the respective modules. For example, logic module 1 1002 and logic module 2 1006 could be combined in a single logic module that is configured to perform the functionality of both logic module 1 1002 and logic module 2 1006, including selecting reference loans 1040 and selecting selected loan attributes 1060.

In the embodiment of FIG. 10, one or more human users 1080 interact with the data processing system 1000. Users 1080 may perform various functions relating to the configuration of the data processing system 1000, including programming and/or maintaining data processing system 1000 or its constituent logic modules. Users 1080 may also represent operators of the data processing system 1000, such as an employee working for a lender and using data processing system 1000 to process loans, or a government employee using data processing system 1000 to verify loan compliance.

In one implementation, at least one of the users 1080 accesses data processing system 1000 directly via a human input device (e.g., a keyboard). This may happen, for example, when data processing system 1000 is a desktop computer and a user is operating the desktop computer directly. In another implementation, at least one of the users 1080 accesses data processing system 1000 via a communication network. This may happen, for example, when data processing system 1000 is a server computer or a service operating in a cloud system, and a user is logging into the server or cloud system remotely.

The access of users 1080 to data processing system 1000 may be regulated using a security clearance model based on credentials of specific human users 1080. For example, a more limited credential profile for a non-managerial employee could permit the respective human user to only access specific functions of the data processing system 1000 or to only process specific loans. Such a security clearance model could be implemented using a login (e.g., username and password) validation model.

Users 1080 may also access data processing system 1000 indirectly via one or more separate portals or systems, interacting directly or indirectly with data processing system 1000.

The performance metric 1090, the characteristic metric 1092 and any other data produced and/or output by data processing system 1000 may be formatted in any file format or using any data format protocol, and may be displayed on a screen, exported, downloaded, emailed or otherwise made available to the respective users 1080.

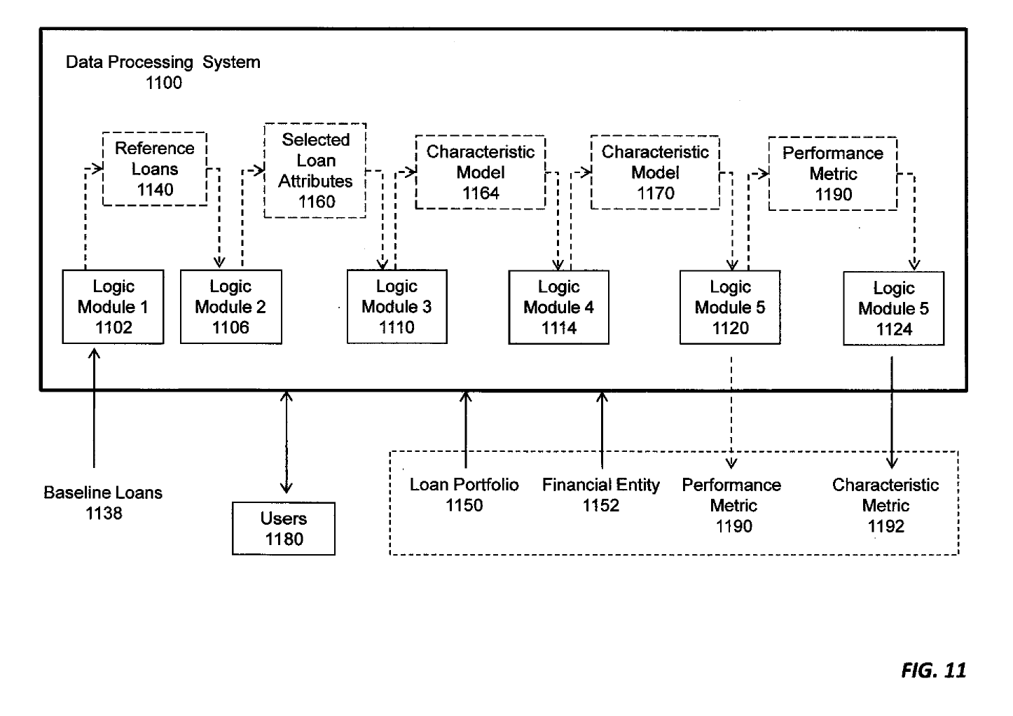

FIG. 11 shows an exemplary data processing system 1100 adapted to assess a characteristic metric of a financial entity based on a portfolio of loans under consideration in accordance with an embodiment of the present invention. The data processing system 1100 is generally similar to the data processing system 1000 described in connection with the embodiment of FIG. 10, but with two relatively significant differences: (1) in the embodiment of FIG. 10, logic module 3 1010 computes one or more score values 1064, while in the embodiment of FIG. 11, logic module 3 1110 computes one or more characteristic models 1164, and (2) in the embodiment of FIG. 10, logic module 4 1014 computes a score value 1070 for the loan portfolio 1050, while in the embodiment of FIG. 11, logic module 4 1114 computes a characteristic model 1170 for the loan portfolio 1150. In the embodiment of FIG. 11, the performance metric 1190 is computed based on the characteristic model 1170, and the characteristic metric 1192 is computed based on the performance metric 1190.

While a score value 1070 represents a quantitative indicator that may be related to a performance metric 1090, a characteristic model 1170 is a method or process that implements an analytic framework that can facilitate computation of a particular performance metric 1190. Examples of such analytic frameworks include rule-based approaches, neural networks and any other analytic or computational framework. In one embodiment, a performance metric 1190 is the risk of default for a loan portfolio. A more general discussion of characteristic models for a portfolio of loans was provided above in connection with the embodiment of FIG. 7, and that discussion is incorporated here by reference. Logic module 5 1120 could then use the result of that process to compute the performance metric 1190.

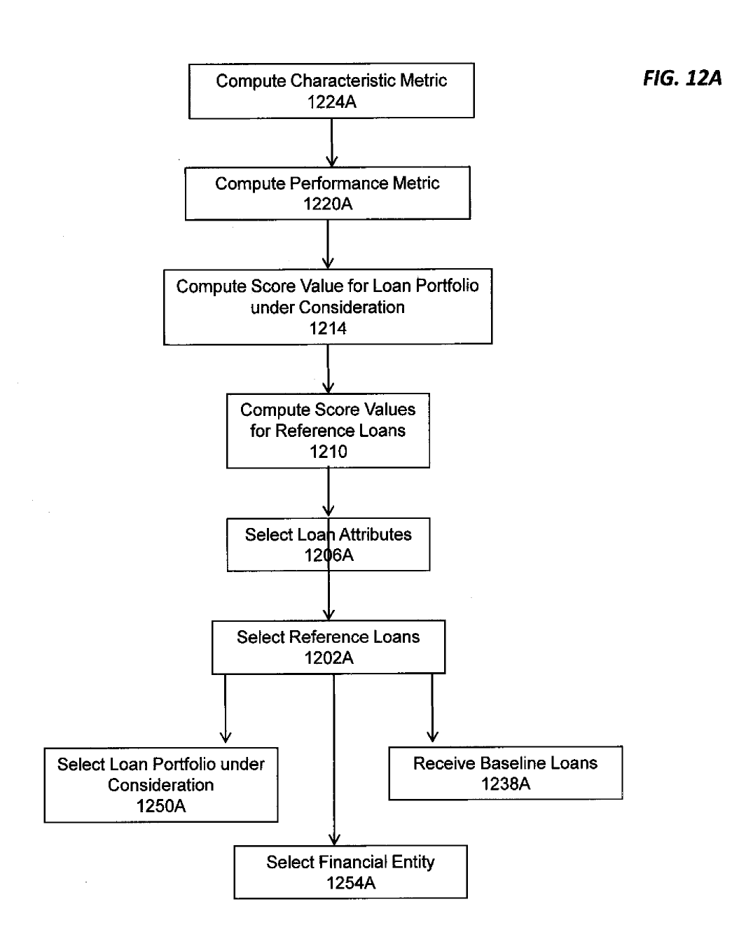

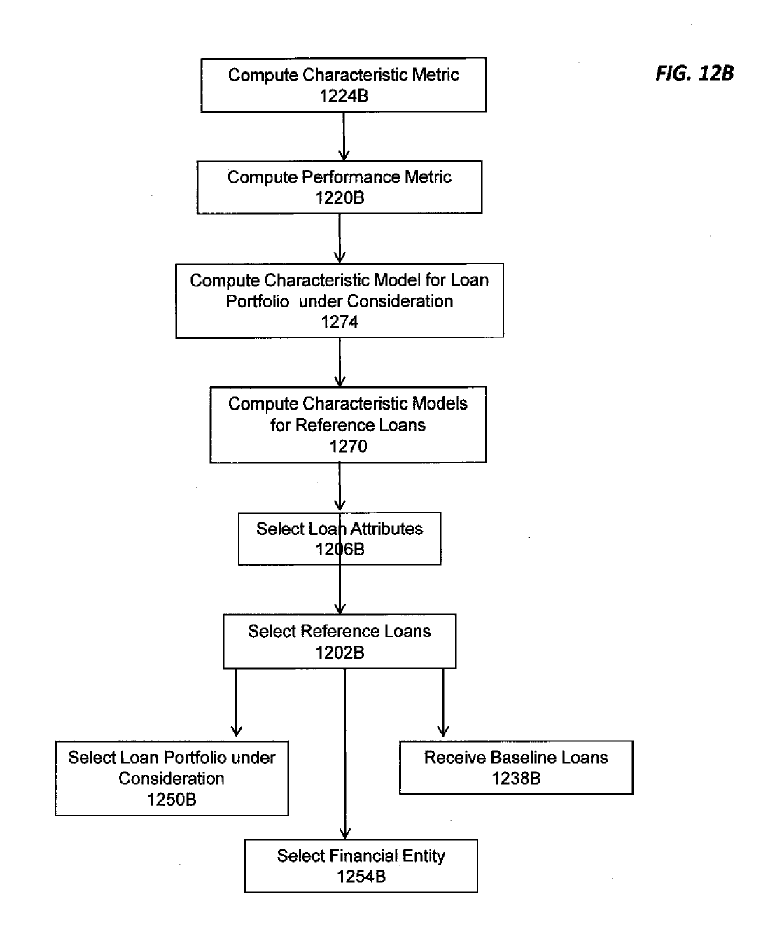

FIG. 12A shows a flowchart illustrating the operation of an exemplary data processing system configured to compute a characteristic metric of a financial entity based on a portfolio of loans in accordance with an embodiment of the present invention. In one implementation, the set of steps shown in the embodiment of FIG. 12A may be performed with the data processing system 1000 shown in FIG. 10, as described in more detail in connection with the embodiment of FIG. 10.

In the embodiment of FIG. 12A, the exemplary data processing system receives a set of baseline loans at step 1238A. The data processing system also selects a loan portfolio under consideration at step 1250A; this is the loan portfolio for which a performance metric will be computed at step 1220A. At step 1254A, the data processing system also selects a financial entity associated with the loan portfolio under consideration; this is the financial entity for which a characteristic metric will be computed at step 1224A.

At step 1202A, the exemplary data processing system selects a set of reference loans from the baseline loans received at step 1238A. At step 1206A, the exemplary data processing system selects a set of loan attributes for one or more of the reference loans. At step 1210, the exemplary data processing system computes one or more score values for at least one of the reference loans selected at step 1202A; the computation of these score values is based at least in part on one or more of the attributes selected at step 1206A.

At step 1214, the exemplary data processing system computes one or more score values for the loan portfolio under consideration; this computation is based at least in part on one or more of the score values computed at step 1210.

At step 1220A, the exemplary data processing system computes one or more performance metrics for the loan portfolio under consideration; this computation is based at least in part on at least one score value computed at step 1214 for the loan portfolio under consideration.

At step 1224A, the exemplary data processing system computes one or more characteristic metrics for the financial entity associated with the loan portfolio under consideration; this computation is based at least in part on at least one performance metric computed at step 1220A for the loan portfolio under consideration.

In one implementation, one or more of the intermediate results produced in the exemplary flow chart shown in FIG. 12A are received from at least one external source, as further described in connection with the embodiment of FIG. 13. Such intermediate results may include the selection of reference loans, the selection of loan attributes and the computation of score values for reference loans and/or for the loan portfolio under consideration.

FIG. 12B shows a flowchart illustrating the operation of an exemplary data processing system configured to compute a performance metric for a loan portfolio under consideration in accordance with an embodiment of the present invention. The flowchart of FIG. 12B is similar to the flowchart shown in FIG. 12A, except that the computation of score values at steps 1210 and 1214 is replaced by the computation of characteristic models at steps 1270 and respectively 1274. In one implementation, only the computation of score values at 1210 is replaced by the computation of characteristic models at step 1270. In an alternative implementation, only the computation of score values at 1214 is replaced by the computation of characteristic models at step 1274.

In one implementation, the set of steps shown in the embodiment of FIG. 12B may be performed with the data processing system 1100 shown in FIG. 11, as described in more detail in connection with the embodiment of FIG. 11.

In the embodiment of FIG. 12B, the exemplary data processing system receives a set of baseline loans at step 1238B. The data processing system also selects a loan portfolio under consideration at step 1250B; this is the loan portfolio for which a performance metric will be computed at step 1220B. At step 1254B, the data processing system also selects a financial entity associated with the loan portfolio under consideration; this is the financial entity for which a characteristic metric will be computed at step 1224B.

At step 1202B, the exemplary data processing system selects a set of reference loans from the baseline loans received at step 123813. At step 1206B, the exemplary data processing system selects a set of loan attributes for one or more of the reference loans.

At step 1270, the exemplary data processing system computes one or more characteristic models for at least one of the reference loans selected at step 1202B; the computation of these characteristic models is based at least in part on one or more of the attributes selected at step 1206B.

At step 1274, the exemplary data processing system computes one or more characteristic models for the loan portfolio under consideration; this computation is based at least in part on one or more of the characteristic models computed at step 1270.

At step 1220B, the exemplary data processing system computes one or more performance metrics for the loan portfolio under consideration; this computation is based at least in part on at least one characteristic model computed at step 874 for the loan portfolio under consideration.

At step 1224B, the exemplary data processing system computes one or more characteristic metrics for the financial entity associated with the loan portfolio under consideration; this computation is based at least in part on at least one performance metric computed at step 1220B for the loan portfolio under consideration.

In one implementation, one or more of the intermediate results produced in the exemplary flow chart shown in FIG. 12B are received from at least one external source, as further described in connection with the embodiment of FIG. 13. Such intermediate results may include the selection of reference loans, the selection of loan attributes and the computation of characteristic models for reference loans and/or for the loan portfolio under consideration.

A. Intermediate Results

FIG. 13 shows an exemplary data processing system 1300 adapted to assess a characteristic metric for a financial entity associated with a loan portfolio under consideration in accordance with an embodiment of the present invention. In the embodiment of FIG. 13, the data processing system 1300 performs a function similar to the function performed by the embodiments shown in FIG. 10 (and respectively 12A) and FIG. 11 (and respectively 12B), except that one or more of the intermediate results computed by the logic modules included in the data processing system 1000 and respectively data processing system 1100 are received from at least one external source, as opposed to being directly computed. Such intermediate results include the selection of reference loans, the selection of loan attributes and the computation of score values and characteristic models.

In the embodiment of FIG. 13, the data processing system 1300 obtains loan portfolio 1310, financial entity 1354 (e.g., the entity's name or other identification information), one or more of reference loans 1320, one or more of selected loan attributes 1330, one or more of score values 1340, and/or one or more of characteristic models 1342 from a database 1350. Database 1350 is hosted by a set of storage memories. In FIG. 13, the arrow lines connecting database 1350 and loan portfolio 1310, financial entity 1354, reference loans 1320, selected loan attributes 1330, score values 1340 and characteristic models 1342 are dashed to emphasize that loan portfolio 1310 and the intermediate results may or may not be obtained from the database 1350.

In one embodiment, the score values 1340 shown in the embodiment of FIG. 13 represent the score values 1064 and possibly the score value 1070 from the embodiment of FIG. 10. In one embodiment, the characteristic models 1342 shown in the embodiment of FIG. 13 represent the characteristic models 1164 and possibly the characteristic model 1170 from the embodiment of FIG. 11. For simplicity, the discussion of the embodiment in FIG. 13 will focus on score values, but this discussion would be analogously applicable to characteristic models as well.

In one implementation, external vendor 1398 provides at least a subset of the reference loans 1320 and at least a subset of the selected loan attributes 1330 to the data processing system 1300, and the data processing system 1300 then computes score values 1340, the performance metric 1390 and characteristic metric 1394. In an alternative implementation, external vendor 1398 provides at least a subset of the reference loans 1320, at least a subset of the selected loan attributes 1330, at least a subset of the score values 1340 to the data processing system 1300, and the data processing system 1300 then computes the performance metric 1390 and the characteristic metric 1394. In one - implementation, external vendor 1398 provides at least a subset of the reference loans 1320, at least a subset of the selected loan attributes 1330, at least a subset of the score values 1340, and at least part of the performance metric 1390 to the data processing system 1300, and the data processing system 1300 then computes characteristic metric 1394. In one implementation, external vendor 1398 provides the loan portfolio 1310 and/or the financial entity 1354.

In one embodiment, the score values 1340 also include a score value for the loan portfolio 1310 for which the performance metric 1390 will be computed. Alternatively stated, the score value 1070 computed as an intermediate result in the embodiment of FIG. 10 and the characteristic model 1170 computed as an intermediate result in the embodiment of FIG. 11 may also be developed by the external vendor 1398 and may be provided to the data processing system 1300 and/or to user 1380 as part of the score values 1340. This could be advantageous, for example, if the data processing system will be processing one or more loans that have already been analyzed at least in part by the external vendor 1398, in which case the external vendor 1398 would be able to provide at least partial intermediate results for those loans.

The external vendor 1398 may be any company, system, service provider or other entity that can provide such intermediate results and/or the loan under consideration. In one embodiment, the external vendor 1398 may be the user 1380. This may happen, for example, if the user 1380 is able to produce or otherwise provide any of the intermediate results, whether in addition to, or independent of the loan portfolio 1310. In various embodiments, the external vendor 1398 may include multiple companies, systems, service providers or other entities, each of these acting as an external vendor with respect to one or more intermediate results or with respect to the loan portfolio 1310. For example, the user 1380 may provide the loan portfolio 1310, the financial entity 1354 and the reference loans 1320, an external service provider with expertise in loan processing may generate selected loan attributes 1330, and another service provider may generate all other intermediate results.

In one implementation, database 1350 is completely included within the data processing system 1300. In one implementation, database 1350 is completely external to the data processing system 1300, possibly stored on a storage memory attached to the data processing system 1300 via a local connection (e.g., a USB or WiFi interface), or possibly stored on a storage memory coupled to the data processing system 1300 via a network (e.g., a remote cloud-based memory volume). In one implementation, part of the database 1350 is included within the data processing system 1300, and part of the database 1350 is external to the data processing system 1300.

An advantage of determining in advance at least some of the reference loans 1320, selected loan attributes 1330, and/or score values 1340 is that the architecture and operation of the data processing system 1300 may be simplified by reducing the need for computing such intermediate results when computing the performance metric of the loan under consideration. Another advantage of determining such intermediate results in advance and making them available to the data processing system on demand is that at least some of the reference loans 1320, selected loan attributes 1330, and/or score values 1340 may be determined by an external vendor and provided to the data processing system 1300 and/or to one or more of the users 1380 on demand. Having an external vendor develop such intermediate results independent of the operation of data processing system 1300 by users 1380 may ensure a higher accuracy in the models because the external vendor may have access to a broader set of loans and loan attributes, and/or may be able to develop more sophisticated and timely models for the computation of such intermediate results.

In general, external vendor 1398 may determine some or all of the reference loans 1320, selected loan attributes 1330 and score values 1340, and may make such intermediate results available to the data processing system 1300. In one implementation, external vendor 1398 provides to data processing system 1300 and/or to user 1380 at least some of the reference loans 1320, selected loan attributes 1330, and/or score values 1340, either by storing them in database 1350 or by transmitting them directly to the data processing system 1300.

In one implementation, external vendor 1398 manages database 1350 by hosting the database 1350 on a storage memory controlled by external vendor 1398. In one implementation, external vendor 1398 permits data processing system 1300 and/or users 980 to access these intermediate results on demand from a storage memory controlled by the external vendor 1398, using a login and password or another security framework. In one implementation, the external vendor 1398 is hosting these intermediate results on a website or on an electronic commerce portal accessible through a communication network. In one implementation, external vendor 1398 provides at least some of the reference loans 1320, selected loan attributes 1330, and/or score values 1340 on a portable storage medium, such as a DVD or another optical medium, or on a portable storage drive (e.g., a USB flash memory drive).

In the embodiment of FIG. 13, the loan 1310, the reference loans 1320, the selected loan attributes 1330, and/or the score values 1340 may be in any data format as long as the format is recognized and can be processed by the data processing system 1300 and/or by its constituent logic modules (if any). For example, some or all of the loan 1310, reference loans 1320, selected loan attributes 1330, and/or score values 1340 may be encrypted, compressed, or formatted in a data file that complies with a specific protocol (e.g., XML).

As long as such intermediate results are in a format that is recognized and can be processed by the data processing system 1300 and/or by its constituent logic modules (if any), the intermediate results are construed to be adapted to be used by the data processing system 1300 as a basis for the assessment of the performance metric 1390 and/or characteristic metric 1394, regardless of whether any such intermediate result may be further processed or combined with other data. For example, a particular attribute included in the selected loan attributes 1330 may be formatted using a particular meta tag that is recognized by the data processing system 1300, but the data processing system may need to extract only part of the data included in that attribute (e.g., extracting the first and last name of a borrower and ignoring any middle name or initial). In general, as long as an intermediate result is made available and is usable as a basis for the assessment of the performance metric 1390 and/or characteristic metric 1394, such intermediate result is construed to be adapted for such use, regardless of whether the intermediate result is further processed and/or is combined with other intermediate results or other data.

In some implementations, at least one of the data processing systems 1000, 1100 or 1300 may be a service hosted on a server and accessible by users remotely (e.g., in a cloud computing application), may be a software application that is installed in whole or in part on a user's personal computer, may operate in a web browser (e.g., as a Java script or Java applet), or may be any other software application or software process that runs locally or remotely relative to the user.

In some implementations, at least one of the data processing systems 1000, 1100 or 1300 may be specific to a particular user (e.g., a software application or computer system configured to be used by a single user using specific credentials). In some implementations, at least one of the data processing systems 1000, 1100 or 1300 may be configured to be used by a plurality of users (e.g., a customer relationship management (CRM) application that may or may not require user credentials).

4. Financial Instrument Analysis

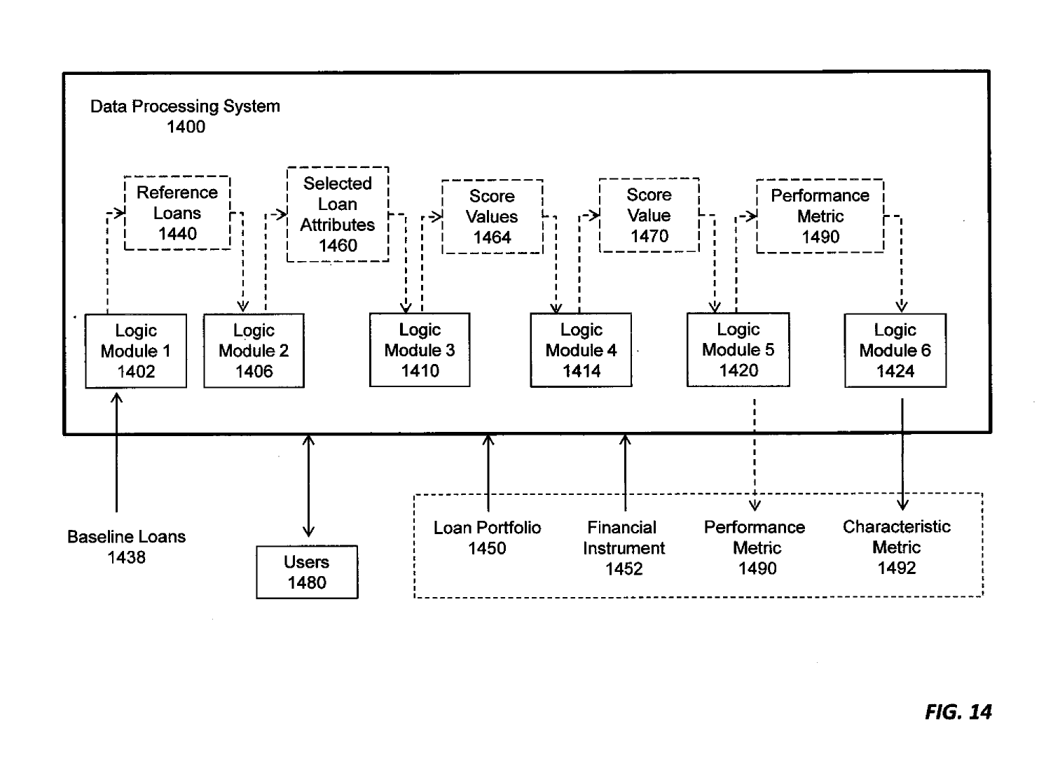

FIG. 14 shows an exemplary data processing system 1400 adapted to assess a characteristic metric of a financial instrument based on a portfolio of loans under consideration in accordance with an embodiment of the present invention.

A general discussion of financial instruments was provided above in connection with the embodiment of FIG. 10. For purposes of various embodiments described in this patent, a financial instrument may be construed to be associated with a portfolio of loans when the financial instrument is at least partially secured or otherwise backed by at least one loan included in that portfolio of loans, or if the value of the financial instrument is otherwise directly or indirectly dependent on at least one loan included in that portfolio of loans.

It may sometimes be advantageous to assess one or more loan-related characteristic metrics for a financial instrument associated with a portfolio of loans. In one example, the potential for financial loss or gain from association with a financial instrument may be directly or indirectly related to the performance of one or more loans within a portfolio of loans that are or have previously been associated with the financial instrument. A potential investor, insurer, or other entity that currently has or is contemplating having a monetary stake in the financial instrument may wish to assess one or more loan-related characteristic metrics for the financial instrument in order to rate the financial instrument according to risks that may be associated with having or continuing to have a monetary stake in the financial instrument. For example, such a characteristic metric might indicate a high risk for a financial instrument that was more likely to lose value due to certain characteristics of one or more loans in a portfolio of loans associated with the financial instrument, for example the likelihood that one or more loans in the portfolio could go into default. Assessing one or more loan-related characteristic metrics for a financial instrument associated with a portfolio of loans may be used to compute a rating for the financial instrument (e.g. investment-grade, speculative, junk), a monetary estimate of gain or loss due to the financial instrument, or any other metric that is related to the financial instrument.

An example of a characteristic metric of a financial instrument associated with a portfolio of loans is a rating of the financial instrument. An example of a rating would be the likelihood that the financial instrument is associated with one or more loans in default that are included in the respective portfolio of loans. Another example of a rating would be the likelihood that the financial instrument is associated with one or more noncompliant loans that are included in the respective portfolio of loans.

Another example of a characteristic metric of a financial instrument associated with a portfolio of loans is the expected financial performance of the financial instrument based on the financial instrument's association with the portfolio of loans. Examples of such expected financial performance would include expected value appreciation or expected value decrease for the respective financial instrument based on one or more of the loans included in the portfolio of loans.

The data processing system 1400 shown in the embodiment of FIG. 14 comprises logic module 1 1402, logic module 2 1406, logic module 3 1410, logic module 4 1414, logic module 5 1420 and logic module 6 1424 that are configured to performed various functions in connection with the computation of a performance metric 1090 for the loan portfolio under consideration, denoted loan portfolio 1450, and a characteristic metric 1492 for a financial instrument 1452 associated with the loan portfolio 1450.

In one embodiment, logic module 1 1402 is configured to select a set of reference loans 1440. Reference loans 1440 may be used in connection with the assessment of performance metric 1490. In one implementation, some or all of the loans included in the reference loans 1440 may have been previously processed in whole or in part to extract, partition or otherwise identify specific data within such loans (e.g., for example scanning a hard copy of a loan and performing optical character recognition to identify the identity of the respective borrower). Reference loans 1440 are stored in one or more storage memories (not shown in FIG. 14) that are directly or indirectly accessible by logic module 1 1402. For example, logic module 1 1402 may access some or all of the reference loans 1440 in a storage memory included within data processing system 1400, or may retrieve reference loans 1440 from an external storage memory that is located in a cloud computing system via a communication network. Alternatively, some or all reference loans 1440 may be transmitted to logic module 1 1402 via email, via FTP, or via any other communication method that could make reference loans 1440 available to logic module 1 1402.

In one embodiment, logic module 1 1402 selects reference loans 1440 from a larger set of loans included in baseline loans 1438, using specific criteria. For example, logic module 1 1402 may select loans with similar attributes to the loans for which performance metrics need to be generated such as selecting loans originated, closed, or funded within similar time-frames, loans with similar types of property securing the loans, loans with similar geographic locations of borrowers, or loans with similar geographic locations of properties securing the loans, or loans with any other attributes that would help ensure that the performance metrics of the selected loans will be relevant to the performance metrics of the loans for which performance metrics need to be generated.

Baseline loans 1438 are stored in one or more storage memories (not shown in FIG. 14) that are directly or indirectly accessible by logic module 1 1402. For example, logic module 1 1402 may access some or all of the baseline loans 1438 in a storage memory included within data processing system 1400, or may retrieve baseline loans 1438 from an external storage memory that is located in a cloud computing system via a communication network. Alternatively, some or all baseline loans 1438 may be transmitted to logic module 1 1402 via email, via FTP, or via any other communication method that could make baseline loans 1438 available to logic module 1 1402.

In one embodiment, the reference loans 1440 are made available to the logic module 2 1406, either by being transmitted directly or by being stored in a storage memory that is accessible to the logic module 2 1406.

In one embodiment, each of the logic module 1 1402 has a characteristic set of attributes. A more general discussion of loan attributes was provided above in connection with the embodiment of FIG. 2, and that discussion is incorporated here by reference.

In one embodiment, logic module 2 1406 is configured to select at least one attribute of at least one of the loans included in the reference loans 1440. In one implementation, logic module 2 1406 may select a first set of attributes from one loan included in the reference loans 1440 and may select a second set of attributes from a different loan included in the reference loans 1440, where the first set and the second set of attributes may be the same, may be different, or may include some common attributes. The selected attributes are shown in the embodiment of FIG. 14 as selected loan attributes 1460. For example, selected loan attributes 1460 may consist of all attributes of all loans included in the reference loans 1440. This may happen in a situation where the reference loans 1440 do not include many attributes, or where the analysis performed is intended to maximize the data available. In another example, selected loan attributes 1460 may consist of only one attribute of only one loan included in the reference loans 1440. This may happen when the analysis seeks to minimize the input dataset, or where only one attribute of only one of the loans included in the reference loans 1440 is considered relevant to the analysis. In general, selected loan attributes 1460 may include any other number of attributes and/or reference loans, depending on the selection made by logic module 2 1406. To select attributes for inclusion in the selected loan attributes 1460, logic module 2 1406 may take into account which attributes are expected to be available when the resulting performance metric is used, how relevant the attributes will be to the analysis, or any other criteria for selecting attributes that is appropriate for the baseline loans in question or the desired performance metric.

In one embodiment, the selected loan attributes 1460 are then made available to the logic module 3 1410, either by being transmitted directly or by being stored in a storage memory that is accessible to the logic module 3 1410.

In one embodiment, logic module 3 1410 is configured to compute one or more score values 1464 for at least one of the reference loans included in the reference loans 1440. In one implementation, if logic module 3 1410 processes inconclusive data or otherwise encounters an inconclusive result, the logic module 3 1410 may not compute any score value. This computation may be based on a subset of the attributes included in the selected loan attributes 1460. In one case, score values 1464 include exactly one score value for each of the reference loans included in the reference loans 1440. In another case, score values 1464 include more than one score value for each of the reference loans included in the reference loans 1440. In another case, score values 1464 do not include any score values for a subset of the reference loans included in the reference loans 1440. In general, score values 1464 may include zero or more score values for each of the reference loans included in the reference loans 1440, but at least one of the reference loans included in the reference loans 1440 will have at least one score value.

In one implementation, each of the score values included in score values 1464 is a probability figure that indicates the likelihood that a relevant event will occur. For example, each of the score values included in score values 1464 may indicate a probability that the corresponding loan included in the reference loans 1440 may experience a default by the respective borrower. In another case, each of the score values included in score values 1464 may indicate an expected amount of loss that may be incurred for the corresponding loan included in the reference loans 1440. In another case, one score value included in score values 1464 may indicate a probability that the corresponding loan included in the reference loans 1440 may be out of compliance with one or more government requirements and a second score value included in score values 1464 may indicate the expected amount of financial loss that may be incurred if the loan is out of compliance.

A more general discussion of the computation of score values was provided above in connection with the embodiment of FIG. 2, and that discussion is incorporated here by reference.

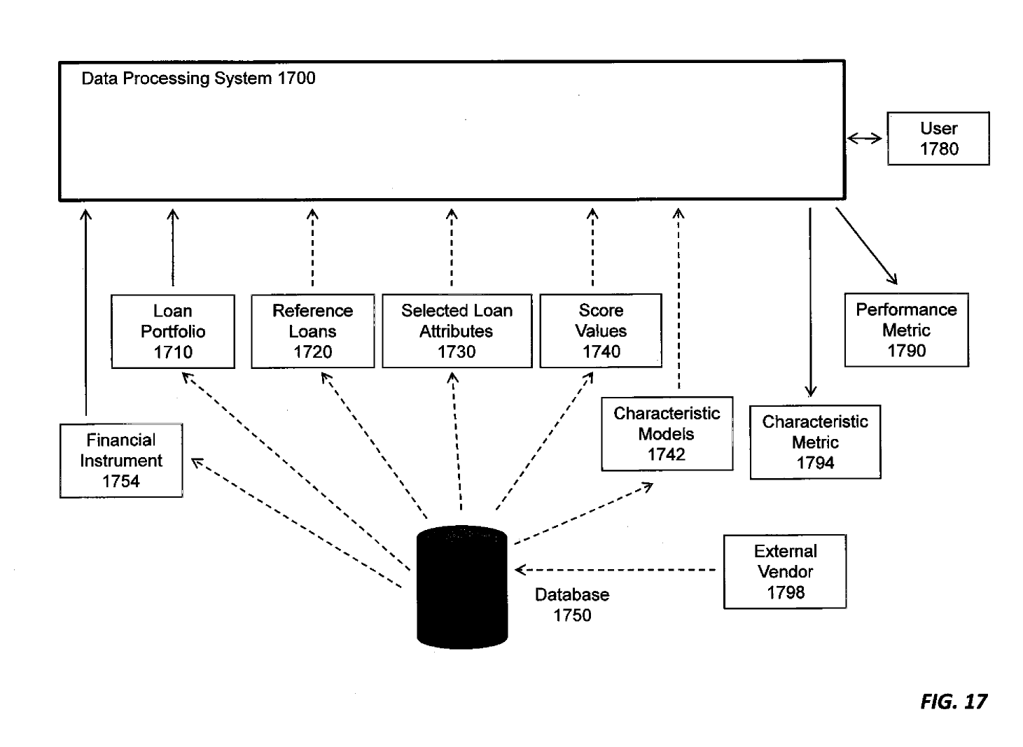

In one embodiment, the computed score values 1464 are stored in a storage memory for future reference, either together with the corresponding loans included in the reference loans 1440 or separately. An advantage of storing the score values 1464 for future reference is that they would not have to be recomputed for subsequent analysis. Also, if the score values 1464 are available in a storage memory and may be retrieved in connection with corresponding reference loans, a data processing system that computes a performance metric would be able to skip the intermediate processing required for the computation of the score values 1464. FIG. 17 shows an embodiment in which score values corresponding to certain reference loans are retrieved from an external storage memory to be used by a data processing system for the computation of a performance metric and/or characteristic metric. In various implementations, score values could also be received, or otherwise retrieved, from a local storage memory or from any other source.

In one embodiment, the computed score values 1464 are then made available to the logic module 4 1414, either by being transmitted directly or by being stored in a storage memory that is accessible to the logic module 4 1414.

Logic module 4 1414 is configured to compute a score value 1470 that consists of one or more individual score values for the loan portfolio 1450. This computation may be based on the computation of one or more of the score values 1464. The score value 1470 may include a probability figure that indicates the likelihood that an event relevant to loan portfolio 1450 will occur, and/or a dollar amount that indicates the likely amount of financial loss associated with loan portfolio 1450. Computation of the score value 1470 may be made using a process analogous with the process described above for the computation of the score values 1464.

In one embodiment, the score value 1470 is made available to the logic module 5 1420, either by being transmitted directly or by being stored in a storage memory that is accessible to the logic module 5 1420. In one implementation, the score value 1470 is also stored in a storage memory for future reference, either together with the loan portfolio 1450 or separately. An advantage of storing the score value 1470 for future reference is that it would not have to be recomputed for subsequent analysis. In one implementation, the score value 1470 is stored together with the score values 1464 for possible future retrieval.

In one embodiment, logic module 5 1420 is configured to compute a performance metric 1490 for the loan portfolio 1450.

An example of performance metric 1490 is the risk of default of at least one loan included in the loan portfolio 1450. A more general discussion of performance metrics for a loan portfolio was provided above in connection with the embodiments of FIG. 2 and FIG. 6, and that discussion is incorporated here by reference.

In one embodiment, logic module 5 1420 computes the performance metric 1490 based on the score value 1470. The process used for the computation of the performance metric 1490 may depend on the nature of the performance metric 1490. A more general discussion of the computation of performance metrics was provided above in connection with the embodiments of FIG. 2 and FIG. 6, and that discussion is incorporated here by reference.

In one embodiment, the performance metric 1490 is made available to the logic module 6 1424, either by being transmitted directly or by being stored in a storage memory that is accessible to the logic module 6 1424. In one implementation, the performance metric 1490 is also stored in a storage memory for future reference, either together with the loan portfolio 1450 or separately. An advantage of storing the score value 1470 for future reference is that it would not have to be recomputed for subsequent analysis. In one implementation, the score value 1470 is stored together with the score values 1464 for possible future retrieval.

In one embodiment, logic module 6 1424 is configured to compute a characteristic metric 1492 for the financial instrument 1452. In one implementation, the data processing system 1400 retrieves or otherwise receives information identifying the financial instrument 1452, including possibly the type, amount, number of individual instruments (e.g., number of shares) included in the financial instrument 1452, an identification number, and/or other data relating to the financial instrument 1452.

An example of a characteristic metric of a financial instrument associated with a portfolio of loans is a rating of the financial instrument. Characteristic metrics were discussed in more detail above in connection with the embodiment shown in FIG. 14.

In one embodiment, logic module 6 1424 computes the characteristic metric 1492 based on the performance metric 1490. The process used for the computation of the characteristic metric 1492 may depend on the nature of the characteristic metric 1492 and/or the performance metric 1490. Computation of a characteristic metric for a financial instrument under consideration may be achieved by using a computed performance metric that relates to a loan portfolio that the financial instrument is associated with, determining the extent to which the loan portfolio could have a material impact on the financial instrument based on how the financial instrument is related to the loan portfolio, and adjusting, scaling or otherwise incorporating, in whole or in part, the computed performance metric for the loan portfolio to arrive at a computed characteristic metric for the financial instrument. In one example, a financial instrument may have a limited exposure to expected financial losses in a loan portfolio with which it is associated because only 10% of its value is derived directly or indirectly from the loan portfolio. In this example the characteristic metric may be computed by taking the computed performance metric for the loan portfolio with which the financial instrument is associated and adjusting it in the course of computing the characteristic metric for the financial instrument in order to reflect the limited influence that the loan portfolio has on the financial entity.

In one embodiment, the performance metric 1490 is an intermediate result that is used in the course of the computation of the characteristic metric 1492, and then it is output by the data processing system 1400 and/or is stored for further future use. In another embodiment, the performance metric 1490 is an intermediate result that is used in the course of the computation of the characteristic metric 1492, but is not output by the data processing system 1400 and is not stored for further use.

In the data processing system 1400 described in connection with the embodiment of FIG. 14 logic module 1 1402, logic module 2 1406, logic module 3 1410, logic module 4 1414, logic module 5 1420 and logic module 6 1424 are independent modules and perform their respective functions independent of each other. In alternative embodiments, one or more of logic module 1 1402, logic module 2 1406, logic module 3 1410, logic module 4 1414, logic module 5 1420 and logic module 6 1424 may be combined in whole or in part in one or more logic module that perform all or part of the functionality of each of the respective modules. For example, logic module 1 1402 and logic module 2 1406 could be combined in a single logic module that is configured to perform the functionality of both logic module 1 1402 and logic module 2 1406, including selecting reference loans 1440 and selecting selected loan attributes 1460.

In the embodiment of FIG. 14, one or more human users 1480 interact with the data processing system 1400. Users 1480 may perform various functions relating to the configuration of the data processing system 1400, including programming and/or maintaining data processing system 1400 or its constituent logic modules. Users 1480 may also represent operators of the data processing system 1400, such as an employee working for a lender and using data processing system 1400 to process loans, or a government employee using data processing system 1400 to verify loan compliance.

In one implementation, at least one of the users 1480 accesses data processing system 1400 directly via a human input device (e.g., a keyboard). This may happen, for example, when data processing system 1400 is a desktop computer and a user is operating the desktop computer directly. In another implementation, at least one of the users 1480 accesses data processing system 1400 via a communication network. This may happen, for example, when data processing system 1400 is a server computer or a service operating in a cloud system, and a user is logging into the server or cloud system remotely.

The access of users 1480 to data processing system 1400 may be regulated using a security clearance model based on credentials of specific human users 1480. For example, a more limited credential profile for a non-managerial employee could permit the respective human user to only access specific functions of the data processing system 1400 or to only process specific loans. Such a security clearance model could be implemented using a login (e.g., username and password) validation model.

Users 1480 may also access data processing system 1400 indirectly via one or more separate portals or systems, interacting directly or indirectly with data processing system 1400.

The performance metric 1490, the characteristic metric 1492 and any other data produced and/or output by data processing system 1400 may be formatted in any file format or using any data format protocol, and may be displayed on a screen, exported, downloaded, emailed or otherwise made available to the respective users 1480.

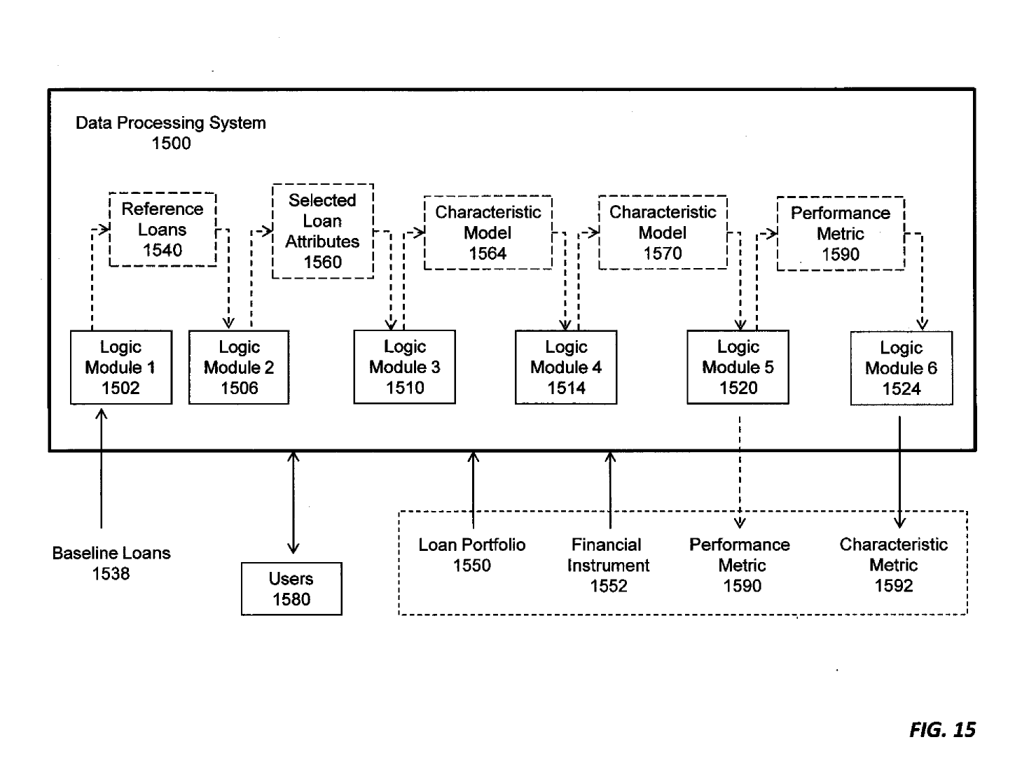

FIG. 15 shows an exemplary data processing system 1500 adapted to assess a characteristic metric of a financial instrument based on a portfolio of loans under consideration in accordance with an embodiment of the present invention. The data processing system 1500 is generally similar to the data processing system 1400 described in connection with the embodiment of FIG. 14, but with two relatively significant differences: (1) in the embodiment of FIG. 14, logic module 3 1410 computes one or more score values 1464, while in the embodiment of FIG. 15, logic module 3 1510 computes one or more characteristic models 1564, and (2) in the embodiment of FIG. 14, logic module 4 1414 computes a score value 1470 for the loan portfolio 1450, while in the embodiment of FIG. 15, logic module 4 1514 computes a characteristic model 1570 for the loan portfolio 1550. In the embodiment of FIG. 15, the performance metric 1590 is computed based on the characteristic model 1570, and the characteristic metric 1592 is computed based on the performance metric 1590.

While a score value 1470 represents a quantitative indicator that may be related to a performance metric 1490, a characteristic model 1570 is a method or process that implements an analytic framework that can facilitate computation of a particular performance metric 1590. Examples of such analytic frameworks include rule-based approaches, neural networks and any other analytic or computational framework. In one embodiment, a performance metric 1590 is the risk of default for a loan portfolio. A more general discussion of characteristic models for a portfolio of loans was provided above in connection with the embodiment of FIG. 7, and that discussion is incorporated here by reference. Logic module 5 1520 could then use the result of that process to compute the performance metric 1590.

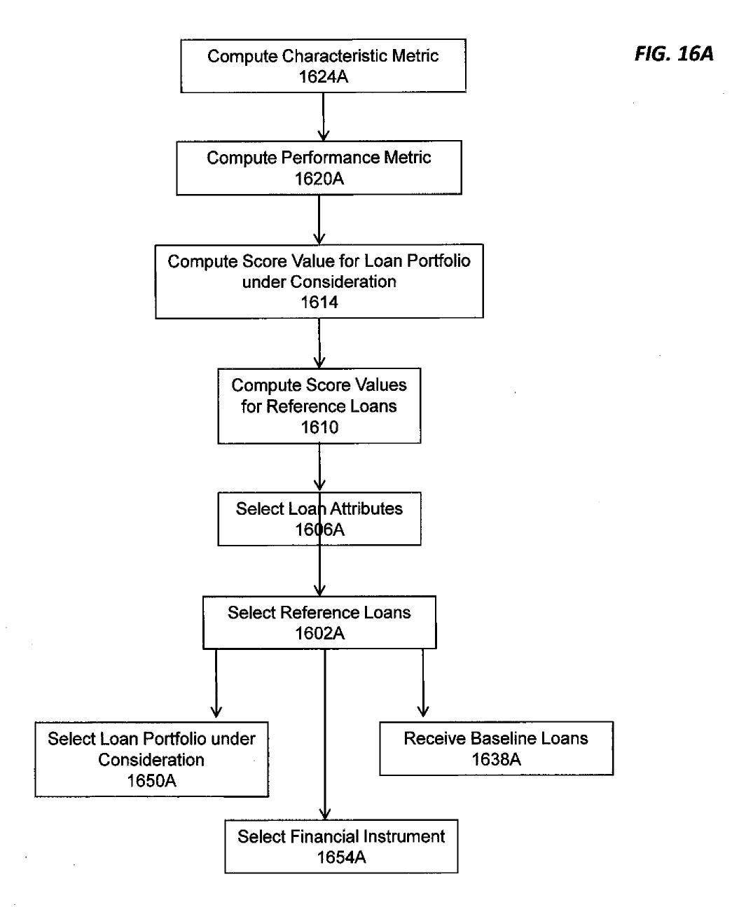

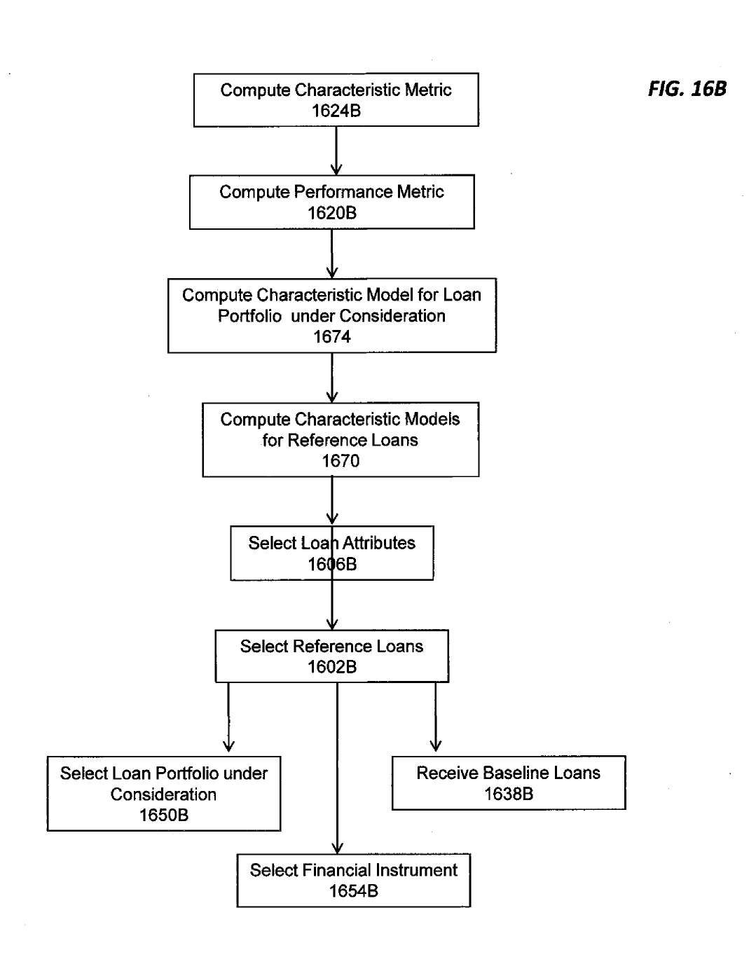

FIG. 16A shows a flowchart illustrating the operation of an exemplary data processing system configured to compute a characteristic metric of a financial instrument associated with under consideration in accordance with an embodiment of the present invention. In one implementation, the set of steps shown in the embodiment of FIG. 16A may be performed with the data processing system 1400 shown in FIG. 14, as described in more detail in connection with the embodiment of FIG. 14.

In the embodiment of FIG. 16A, the exemplary data processing system receives a set of baseline loans at step 1638A. The data processing system also selects a loan portfolio under consideration at step 1650A; this is the loan portfolio for which a performance metric will be computed at step 1620A. At step 1654A, the data processing system also selects a financial instrument associated with the loan portfolio under consideration; this is the financial instrument for which a characteristic metric will be computed at step 1624A.

At step 1602A, the exemplary data processing system selects a set of reference loans from the baseline loans received at step 1638A. At step 1606A, the exemplary data processing system selects a set of loan attributes for one or more of the reference loans. At step 1610, the exemplary data processing system computes one or more score values for at least one of the reference loans selected at step 1602A; the computation of these score values is based at least in part on one or more of the attributes selected at step 1606A.

At step 1614, the exemplary data processing system computes one or more score values for the loan portfolio under consideration; this computation is based at least in part on one or more of the score values computed at step 1610.

At step 1620A, the exemplary data processing system computes one or more performance metrics for the loan portfolio under consideration; this computation is based at least in part on at least one score value computed at step 1614 for the loan portfolio under consideration.

At step 1624A, the exemplary data processing system computes one or more characteristic metrics for the financial instrument associated with the loan portfolio under consideration; this computation is based at least in part on at least one performance metric computed at step 1620A for the loan portfolio under consideration.

In one implementation, one or more of the intermediate results produced in the exemplary flow chart shown in FIG. 16A are received from at least one external source, as further described in connection with the embodiment of FIG. 13. Such intermediate results may include the selection of reference loans, the selection of loan attributes and the computation of score values for reference loans and/or for the loan portfolio under consideration.

FIG. 16B shows another flowchart illustrating the operation of an exemplary data processing system configured to compute a characteristic metric of a financial instrument associated with a portfolio of loans under consideration in accordance with an embodiment of the present invention. The flowchart of FIG. 16B is similar to the flowchart shown in FIG. 16A, except that the computation of score values at steps 1610 and 1614 is replaced by the computation of characteristic models at steps 1670 and respectively 1674. In one implementation, only the computation of score values at 1610 is replaced by the computation of characteristic models at step 1670. In an alternative implementation, only the computation of score values at 1614 is replaced by the computation of characteristic models at step 1674.

In one implementation, the set of steps shown in the embodiment of FIG. 16B may be performed with the data processing system 1500 shown in FIG. 15, as described in more detail in connection with the embodiment of FIG. 15.

In the embodiment of FIG. 16B, the exemplary data processing system receives a set of baseline loans at step 163 8B. The data processing system also selects a loan portfolio under consideration at step 1650B; this is the loan portfolio for which a performance metric will be computed at step 1620B. At step 1654B, the data processing system also selects a financial instrument associated with the loan portfolio under consideration; this is the financial instrument for which a characteristic metric will be computed at step 1624B.

At step 1602B, the exemplary data processing system selects a set of reference loans from the baseline loans received at step 1638B. At step 1606B, the exemplary data processing system selects a set of loan attributes for one or more of the reference loans.

At step 1670, the exemplary data processing system computes one or more characteristic models for at least one of the reference loans selected at step 1602B; the computation of these characteristic models is based at least in part on one or more of the attributes selected at step 1606B.

At step 1674, the exemplary data processing system computes one or more characteristic models for the loan portfolio under consideration; this computation is based at least in part on one or more of the characteristic models computed at step 1670.

At step 1620B, the exemplary data processing system computes one or more performance metrics for the loan portfolio under consideration; this computation is based at least in part on at least one characteristic model computed at step 1674 for the loan portfolio under consideration.

At step 1624B, the exemplary data processing system computes one or more characteristic metrics for the financial instrument associated with the loan portfolio under consideration; this computation is based at least in part on at least one performance metric computed at step 1620B for the loan portfolio under consideration.

In one implementation, one or more of the intermediate results produced in the exemplary flow chart shown in FIG. 16B are received from at least one external source, as further described in connection with the embodiment of FIG. 13. Such intermediate results may include the selection of reference loans, the selection of loan attributes and the computation of characteristic models for reference loans and/or for the loan portfolio under consideration.

A. Intermediate Results

FIG. 17 shows an exemplary data processing system 1700 adapted to assess a characteristic metric for a financial instrument associated with a loan portfolio under consideration in accordance with an embodiment of the present invention. In the embodiment of FIG. 17, the data processing system 1700 performs a function similar to the function performed by the embodiments shown in FIG. 14 (and respectively 16A) and FIG. 15 (and respectively 16B), except that one or more of the intermediate results computed by the logic modules included in the data processing system 1400 and respectively data processing system 1500 are received from at least one external source, as opposed to being directly computed. Such intermediate results include the selection of reference loans, the selection of loan attributes and the computation of score values and characteristic models.

In the embodiment of FIG. 17, the data processing system 1700 obtains loan portfolio 1710, financial instrument 1754 (e.g., the type, amount, value, or other identification information), one or more of reference loans 1720, one or more of selected loan attributes 1730, one or more of score values 1740, and/or one or more of characteristic models 1742 from a database 1750. Database 1750 is hosted by a set of storage memories. In FIG. 17, the arrow lines connecting database 1750 and loan portfolio 1710, financial instrument 1754, reference loans 1720, selected loan attributes 1730, score values 1740 and characteristic models 1742 are dashed to emphasize that loan portfolio 1710 and the intermediate results may or may not be obtained from the database 1750.

In one embodiment, the score values 1740 shown in the embodiment of FIG. 17 represent the score values 1464 and possibly the score value 1470 from the embodiment of FIG. 14. In one embodiment, the characteristic models 1742 shown in the embodiment of FIG. 17 represent the characteristic models 1564 and possibly the characteristic model 1570 from the embodiment of FIG. 15. For simplicity, the discussion of the embodiment in FIG. 17 will focus on score values, but this discussion would be analogously applicable to characteristic models as well.

In one implementation, external vendor 1798 provides at least a subset of the reference loans 1720 and at least a subset of the selected loan attributes 1730 to the data processing system 1700, and the data processing system 1700 then computes score values 1740, the performance metric 1790 and characteristic metric 1794. In an alternative implementation, external vendor 1798 provides at least a subset of the reference loans 1720, at least a subset of the selected loan attributes 1730, at least a subset of the score values 1740 to the data processing system 1700, and the data processing system 1700 then computes the performance metric 1790 and the characteristic metric 1794. In one implementation, external vendor 1798 provides at least a subset of the reference loans 1720, at least a subset of the selected loan attributes 1730, at least a subset of the score values 1740, and at least part of the performance metric 1790 to the data processing system 1700, and the data processing system 1700 then computes characteristic metric 1794. In one implementation, external vendor 1798 provides the loan portfolio 1710 and/or the financial instrument 1754.

In one embodiment, the score values 1740 also include a score value for the loan under consideration for which the performance metric 1790 will be computed. Alternatively stated, the score value 1470 computed as an intermediate result in the embodiment of FIG. 14 and the characteristic model 1570 computed as an intermediate result in the embodiment of FIG. 15 may also be developed by the external vendor 1798 and may be provided to the data processing system 1700 and/or to user 1780 as part of the score values 1740. This could be advantageous, for example, if the data processing system will be processing one or more loans that have already been analyzed at least in part by the external vendor 1798, in which case the external vendor 1798 would be able to provide at least partial intermediate results for those loans.

The external vendor 1798 may be any company, system, service provider or other entity that can provide such intermediate results and/or the loan under consideration. In one embodiment, the external vendor 1798 may be the user 1780. This may happen, for example, if the user 1780 is able to produce or otherwise provide any of the intermediate results, whether in addition to, or independent of the loan portfolio 1710. In various embodiments, the external vendor 1798 may include multiple companies, systems, service providers or other entities, each of these acting as an external vendor with respect to one or more intermediate results or with respect to the loan portfolio 1710. For example, the user 1780 may provide the loan portfolio 1710, the financial instrument 1754 and the reference loans 1720, an external service provider with expertise in loan processing may generate selected loan attributes 1730, and another service provider may generate all other intermediate results.

In one implementation, database 1750 is completely included within the data processing system 1700. In one implementation, database 1750 is completely external to the data processing system 1700, possibly stored on a storage memory attached to the data processing system 1700 via a local connection (e.g., a USB or WiFi interface), or possibly stored on a storage memory coupled to the data processing system 1700 via a network (e.g., a remote cloud-based memory volume). In one implementation, part of the database 1750 is included within the data processing system 1700, and part of the database 1750 is external to the data processing system 1700.

An advantage of determining in advance at least some of the reference loans 1720, selected loan attributes 1730, and/or score values 1740 is that the architecture and operation of the data processing system 1700 may be simplified by reducing the need for computing such intermediate results when computing the performance metric of the loan under consideration. Another advantage of determining such intermediate results in advance and making them available to the data processing system on demand is that at least some of the reference loans 1720, selected loan attributes 1730, and/or score values 1740 may be determined by an external vendor and provided to the data processing system 1700 and/or to one or more of the users 1780 on demand. Having an external vendor develop such intermediate results independent of the operation of data processing system 1700 by users 1780 may ensure a higher accuracy in the models because the external vendor may have access to a broader set of loans and loan attributes, and/or may be able to develop more sophisticated and timely models for the computation of such intermediate results.

In general, external vendor 1798 may determine some or all of the reference loans 1720, selected loan attributes 1730 and score values 1740, and may make such intermediate results available to the data processing system 1700. In one implementation, external vendor 1798 provides to data processing system 1700 and/or to user 1780 at least some of the reference loans 1720, selected loan attributes 1730, and/or score values 1740, either by storing them in database 1750 or by transmitting them directly to the data processing system 1700.

In one implementation, external vendor 1798 manages database 1750 by hosting the database 1750 on a storage memory controlled by external vendor 1798. In one implementation, external vendor 1798 permits data processing system 1700 and/or users 980 to access these intermediate results on demand from a storage memory controlled by the external vendor 1798, using a login and password or another security framework. In one implementation, the external vendor 1798 is hosting these intermediate results on a website or on an electronic commerce portal accessible through a communication network. In one implementation, external vendor 1798 provides at least some of the reference loans 1720, selected loan attributes 1730, and/or score values 1740 on a portable storage medium, such as a DVD or another optical medium, or on a portable storage drive (e.g., a USB flash memory drive).

In the embodiment of FIG. 17, the loan 1710, the reference loans 1720, the selected loan attributes 1730, and/or the score values 1740 may be in any data format as long as the format is recognized and can be processed by the data processing system 1700 and/or by its constituent logic modules (if any). For example, some or all of the loan 1710, reference loans 1720, selected loan attributes 1730, and/or score values 1740 may be encrypted, compressed, or formatted in a data file that complies with a specific protocol (e.g., XML).

As long as such intermediate results are in a format that is recognized and can be processed by the data processing system 1700 and/or by its constituent logic modules (if any), the intermediate results are construed to be adapted to be used by the data processing system 1700 as a basis for the assessment of the performance metric 1790 and/or characteristic metric 1794, regardless of whether any such intermediate result may be further processed or combined with other data. For example, a particular attribute included in the selected loan attributes 1730 may be formatted using a particular meta tag that is recognized by the data processing system 1700, but the data processing system may need to extract only part of the data included in that attribute (e.g., extracting the first and last name of a borrower and ignoring any middle name or initial). In general, as long as an intermediate result is made available and is usable as a basis for the assessment of the performance metric 1790 and/or characteristic metric 1794, such intermediate result is construed to be adapted for such use, regardless of whether the intermediate result is further processed and/or is combined with other intermediate results or other data.

In some implementations, at least one of the data processing systems 1400, 1500 or 1700 may be a service hosted on a server and accessible by users remotely (e.g., in a cloud computing application), may be a software application that is installed in whole or in part on a user's personal computer, may operate in a web browser (e.g., as a Java script or Java applet), or may be any other software application or software process that runs locally or remotely relative to the user.

In some implementations, at least one of the data processing systems 1400, 1500 or 1700 may be specific to a particular user (e.g., a software application or computer system configured to be used by a single user using specific credentials). In some implementations, at least one of the data processing systems 1400, 1500 or 1700 may be configured to be used by a plurality of users (e.g., a customer relationship management (CRM) application that may or may not require user credentials).

5. Reduced Datasets

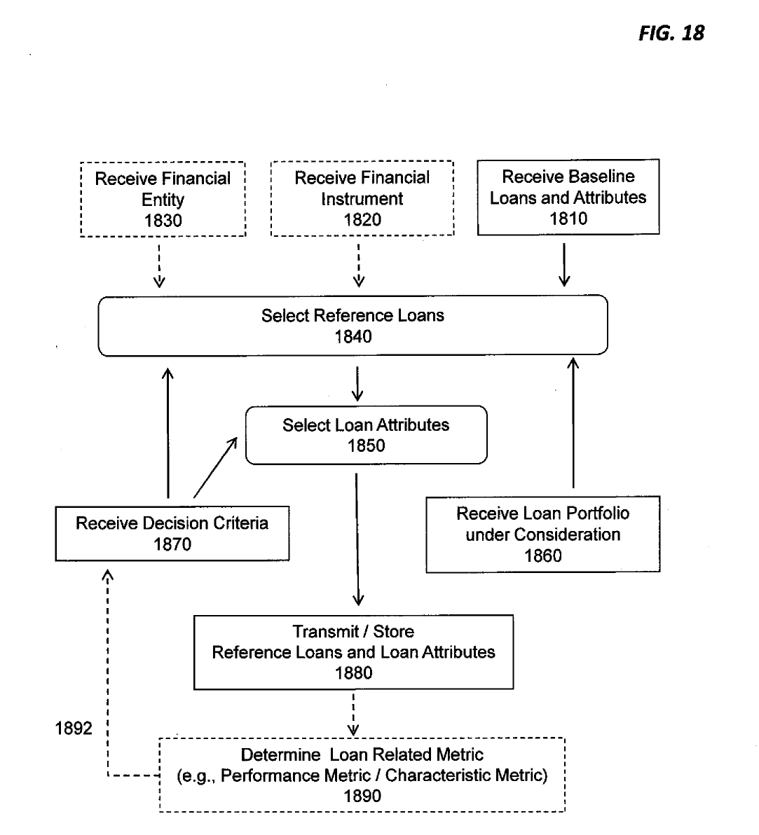

FIG. 18 shows a flowchart illustrating the operation of an exemplary data processing system configured to compute a loan-related metric in accordance with an embodiment of the present invention. The loan-related metric may be a characteristic metric for a financial instrument associated with a portfolio of loans under consideration (e.g., as discussed in connection with the embodiments of FIG. 14 and FIG. 15), a characteristic metric for a financial entity associated with the portfolio of loans under consideration (e.g., as discussed in connection with the embodiments of FIG. 10 and FIG. 11), a performance metric for the portfolio of loans under consideration (e.g., as discussed in connection with the embodiments of FIG. 6 and FIG. 7), or a performance metric for a loan under consideration (e.g., as discussed in connection with the embodiments of FIG. 2 and FIG. 3).

The set of steps shown in the embodiment of FIG. 18 may be performed with the data processing system 200 shown in FIG. 2, data processing system 300 shown in FIG. 3, data processing system 500 shown in FIG. 5, data processing system 600 shown in FIG. 6, data processing system 700 shown in FIG. 7, data processing system 900 shown in FIG. 9, data processing system 1000 shown in FIG. 10, data processing system 1100 shown in FIG. 11, data processing system 1300 shown in FIG. 13, data processing system 1400 shown in FIG. 14, data processing system 1500 shown in FIG. 15, data processing system 1700 shown in FIG. 17, or with any other data processing systems or logic modules appropriately configured to perform such steps.

In the embodiment of FIG. 8, the exemplary data processing system receives a set of baseline loans at step 1810. The data processing system also receives a loan portfolio under consideration at step 1860. If the loan related metric relevant to the computation at step 1890 includes a characteristic metric of a financial instrument, the data processing system receives the respective financial instrument at step 1820. If the loan related metric relevant to the computation at step 1890 includes a characteristic metric of a financial entity, the data processing system receives the respective financial entity at step 1830.

The exemplary data processing system of FIG. 18 also receives a set of decision criteria at step 1870. These decision criteria may be used as a basis for the selection of reference loans and loan attributes in steps 1840 and respectively 1850.

In one example, the decision criteria used as a basis for the selection of reference loans and loan attributes may pertain to how closely a particular potential reference loan relates to one or more loans in the loan portfolio under consideration or which attributes of the potential reference loans cause the potential reference loan to relate to one or more loans in the loan portfolio. This decision criteria may include consideration for how many attributes a specific potential reference loan shares in common with one or more loans in the loan portfolio under consideration or which attributes the specific potential reference loan shares in common with one or more loans in the loan portfolio under consideration. For example, a potential reference loan that shares all attributes in common with one or more loans in the loan portfolio under consideration may be more likely to be selected as a reference loan and/or may lead to all loan attributes of the potential reference loan being selected or a potential reference loan that shares one attribute in common with one or more loans in the loan portfolio under consideration may be more likely to be selected as a reference loan and/or may lead to only one loan attribute being selected.

The set of baseline loans received at step 1810 may include one or more baseline loans. Each of these baseline loans may have zero, one or more attributes. Attributes corresponding to the baseline loans may be received together with the baseline loans, or may be obtained from a different database. In the exemplary embodiment of FIG. 18, attributes are shown as being received at step 1810.

At step 1840, the exemplary data processing system of FIG. 18 selects at least one of the baseline loans for inclusion into the set of reference loans. This selection may be based at least in part on the decision criteria received at step 1870.

In one implementation, the decision to select a particular baseline loan for inclusion into the set of reference loans is based on information included in one or more attributes received at step 1810. The attributes that serve as the basis for this decision may be attributes of the particular baseline loan under consideration, or may correspond to other loans included in the baseline loans received at step 1810.

For example a computed performance metric may pertain to loans that are secured by properties located in all states. In this example, it would be advantageous to have a proportional distribution of loans secured by properties in each state in the set of reference loans and the baseline loans. In this example, the selection of a particular loan to be included in the set of reference loans would depend upon the locations of secured properties of one or more other loans in the baseline loans.

As another example, the decision to select a particular baseline loan for inclusion into the set of reference loans may be based on whether information included in one or more attributes corresponding to that particular baseline loan is available in a digital format. In this example, loans that have specific information available in digital form (e.g., the name and address of the borrowers are available in ASCII format) may be selected for inclusion, and loans that do not have that specific information in digital form would not be selected.

As another example, the decision to select a particular baseline loan for inclusion into the set of reference loans may be based on whether information included in one or more attributes corresponding to that particular baseline loan relates to a regulatory environment, or business or economic practices in a particular jurisdiction. This may occur when the exemplary data processing system of FIG. 18 is computing a loan related metric that relates in particular to a particular jurisdiction and that jurisdiction is characterized by specific legal, business or economic rules or customs. For example the legal framework in California may include specific criteria for determining whether a loan is compliant with applicable regulations, and in that case loans for which attributes include information relevant to that compliance analysis would be selected for inclusion in the set of reference loans, but other loans may not be selected.

As another example, the decision to select a particular baseline loan for inclusion into the set of reference loans may be based on whether information included in one or more attributes corresponding to that particular baseline loan is indicative of a risk of loan default, or of a risk of loan fraud.

In one implementation, the decision to select a particular baseline loan for inclusion into the set of reference loans is based on the relevance to the computation of a loan-related metric of at least one attribute corresponding to one or more baseline loans. For example, if an attribute of a baseline loan under consideration is likely to be relevant to the computation of a characteristic metric of a financial entity, that particular baseline loan may be selected for inclusion in the set of reference loans.

In one implementation, the decision to select a set of loan attributes at step 1850 may be based on whether information included in one or more attributes of one or more baseline loans received at step 1810 and/or one or more loans in a loan portfolio under consideration received in step 1860 is available in a digital format. In this example, loan attributes that have specific information available in digital form (e.g., the name and address of the borrowers are available in ASCII format) may be selected, and attributes that do not have that specific information in digital form would not be selected.

In one embodiment, to determine whether an attribute may or may not be relevant to the computation of the loan-related metric, the exemplary data processing system of FIG. 18 may attempt to compute the respective loan-related metric using that particular attribute (and optionally, as a reference basis, also without using that particular attribute), and then, determine whether the attribute was or was not relevant. This determination regarding the relevance of the attribute to the computation of the loan-related metric may be made at any point during the computation process (e.g., if any intermediate result is invalid or otherwise undesirable). The computation of the loan-related metric is optional with respect to the embodiment shown in FIG. 18 and is illustrated at step 1890 with a dotted line.

The optional use of the results of such a computation as a basis for the selection of attributes is shown via the feedback line 1892. In one implementation, one or more intermediate or final results of the computation of the loan-related metric performed at step 1890 become one or more of the decision criteria shown at step 1870 and are used as a basis for the selection of reference loans and/or the selection of attributes at steps 1840 and respectively 1850. Alternatively, one or more results of the computation of the loan-related metric performed at step 1890 do not become decision criteria themselves, but are used in connection with the decision criteria shown at step 1870 as components of the basis for the selection of reference loans and/or the selection of attributes at steps 1840 and respectively 1850.

At step 1850, the exemplary data processing system of FIG. 18 may also filter out some of the attributes of the reference loans selected at step 1840. In one example, the decision criteria received at step 1870 may indicate that one or more attributes do not have a desired effect on the computation of a loan related metric. In this example, one or more of the attributes that do not have a desired effect on the computation of a loan related metric may be filtered out by not selecting them at step 1850. Alternatively, all attributes of the reference loans selected at step 1840 may be preserved, even if it is known that some of those attributes may not be needed for future computations.

At step 1880, the exemplary data processing system of FIG. 18 transmits and/or stores in a database the selected reference loans and attributes that were selected at steps 1840 and respectively 1850. These reference loans and/or attributes may be subsequently used for computations of loan related metrics by vendors and/or by customers.

A loan-related metric may be computed in accordance with an embodiment of the present invention without one or more of the intermediate steps of selecting reference loans, selecting loan attributes, computing score values, computing characteristic models, etc. The loan-related metric may be a characteristic metric for a financial instrument associated with a portfolio of loans under consideration (e.g., as discussed in connection with the embodiments of FIG. 14 and FIG. 15), a characteristic metric for a financial entity associated with the portfolio of loans under consideration (e.g., as discussed in connection with the embodiments of FIG. 10 and FIG. 11), a performance metric for the portfolio of loans under consideration (e.g., as discussed in connection with the embodiments of FIG. 6 and FIG. 7), or a performance metric for a loan under consideration (e.g., as discussed in connection with the embodiments of FIG. 2 and FIG. 3).

In one embodiment there may be no selection of reference loans and no selection of loan attributes. Alternately there may be a selection of reference loans and no selection of loan attributes or there may not be a selection of reference loans and there may be a selection of loan attributes. In this example, to determine a loan-related metric, one or more baseline loans may be compared one at a time to a loan or one or more loans in a loan portfolio under consideration so as to identify the baseline loans that are most similar to the loan or the loan portfolio under consideration. The assessment of similarity may or may not take into account the loan-related metric being determined. Using one or more identified baseline loans and examining each of them with respect to a loan-related metric of interest an assessment can be made regarding the degree to which a similar loan-related metric for a loan or a loan portfolio under consideration will relate to one or more loan-related metrics of one or more identified baseline loans and a loan-related metric for a loan or a loan portfolio under consideration can be determined accordingly. The process may or may not be augmented by the addition of intermediate steps of determining one or more score values or one or more characteristic models for one or more baseline loans or a loan or a loan portfolio under consideration in order to assist in the determination of a loan-related metric for a loan or a loan portfolio under consideration.

For example, in a case where the loan-related metric is the likelihood of fraud being associated with a loan under consideration, a set of baseline loans can be examined one at a time in order to identify the baseline loans that are most similar to the loan under consideration. In this example one or more examiners could identify the baseline loans that are most similar to the loan under consideration and those baseline loans that were deemed most similar to the loan under consideration or, in the case of multiple examiners, those baseline loans that were most often deemed most similar to the loan under consideration could be selected and used to assist in the determination of the loan-related metric. The selected loans could be examined for likelihood of association with fraud. Based on the likelihood of association with fraud among the selected loans a determination could be made regarding the likelihood of association with fraud for the loan under consideration.

This specification describes in detail various embodiments and implementations of the present invention, and the present invention is open to additional embodiments and implementations, further modifications, and alternative constructions. There is no intention in this patent to limit the invention to the particular embodiments and implementations disclosed; on the contrary, this patent is intended to cover all modifications, equivalents and alternative embodiments and implementations that fall within the scope of the claims.

As used in this specification, the terms “include,” “including,” “for example,” “exemplary,” “e.g.,” and variations thereof, are not intended to be terms of limitation, but rather are intended to be followed by the words “without limitation” or by words with a similar meaning. Definitions in this specification, and all headers, titles and subtitles, are intended to be descriptive and illustrative with the goal of facilitating comprehension, but are not intended to be limiting with respect to the scope of the inventions as recited in the claims. Each such definition is intended to also capture additional equivalent items, technologies or terms that would be known or would become known to a person of average skill in this art as equivalent or otherwise interchangeable with the respective item, technology or term so defined. Unless otherwise required by the context, the verb “may” indicates a possibility that the respective action, step or implementation may be achieved, but is not intended to establish a requirement that such action, step or implementation must occur, or that the respective action, step or implementation must be achieved in the exact manner described.

What is claimed is:

1. A data processing system for assessing a performance metric of a loan under consideration, the data processing system comprising:
a. A logic module configured to receive at least one score value corresponding to at least one reference loan;
b. A logic module configured to compute at least one score value for the loan under consideration, wherein the computation is based on at least one received score value; and
c. A logic module configured to assess the performance metric of the loan under consideration, wherein the assessment is based on at least one score value computed for the loan under consideration.

2. The data processing system of claim 1, wherein the performance metric is the risk of default of the loan under consideration.

3. The data processing system of claim 1, wherein the performance metric is the risk of noncompliance of the loan under consideration with at least one government or market requirement.

4. The data processing system of claim 1, wherein the performance metric is the risk of incidence of fraudulent activity associated with the loan under consideration.

5. The data processing system of claim 1, wherein the performance metric is the expected financial performance of the loan under consideration.

6. The data processing system of claim 5, wherein the financial performance of the loan under consideration is an expected financial loss or an expected financial gain.

7. A computer implemented method for assessing a performance metric of a loan under consideration, the method comprising:
a. receiving at least one score value corresponding to at least one reference loan;
b. based on at least one received score value, computing at least one score value for the loan under consideration;
c. Based on at least one score value computed for the loan under consideration, assessing the performance metric of the loan under consideration.

8. The computer implemented method of claim 7, wherein the performance metric is the risk of default of the loan under consideration.

9. The computer implemented method of claim 7, wherein the performance metric is the risk of noncompliance of the loan under consideration with at least one government or market requirement.

10. The computer implemented method of claim 7, wherein the performance metric is the risk of incidence of fraudulent activity associated with the loan under consideration.

11. The computer implemented method of claim 7, wherein the performance metric is the expected financial performance of the loan under consideration.

12. The computer implemented method of claim 11, wherein the financial performance of the loan under consideration is an expected financial loss or an expected financial gain.

13. A storage memory comprising computer-executable instructions for assessing a performance metric of a loan under consideration, the computer-executable instructions comprising:
a. instructions for receiving at least one score value corresponding to at least one reference loan;
b. instructions for computing at least one score value for the loan under consideration, where the computation is based on at least one received score value;
c. instructions for assessing the performance metric of the loan under consideration, wherein the assessment is based on at least one score value computed for the loan under consideration.

14. The storage memory of claim 13, wherein the storage memory is a magnetic hard disk, a flash memory module, a random access memory module, or an optical disk.

15. The storage memory of claim 13, wherein the computer-executable instructions are in object code format or in source code format.

16. The storage memory of claim 13, wherein the performance metric is the risk of default of the loan under consideration.

17. The storage memory of claim 13, wherein the performance metric is the risk of noncompliance of the loan under consideration with at least one government or market requirement.

18. The storage memory of claim 13, wherein the performance metric is the risk of incidence of fraudulent activity associated with the loan under consideration.

19. The storage memory of claim 13, wherein the performance metric is the expected financial performance of the loan under consideration.

20. The storage memory of claim 19, wherein the financial performance of the loan under consideration is an expected financial loss or an expected financial gain.

21. A data processing system for assessing a performance metric of a loan under consideration, the data processing system comprising:
a. A logic module configured to receive at least one characteristic model corresponding to at least one reference loan;
b. A logic module configured to compute at least one characteristic model for the loan under consideration, wherein the computation is based on at least one received characteristic model; and
c. A logic module configured to assess the performance metric of the loan under consideration, wherein the assessment is based on at least one characteristic model computed for the loan under consideration.

22. The data processing system of claim 21, wherein the performance metric is the risk of default of the loan under consideration.

23. The data processing system of claim 21, wherein the performance metric is the risk of noncompliance of the loan under consideration with at least one government or market requirement.

24. The data processing system of claim 21, wherein the performance metric is the risk of incidence of fraudulent activity associated with the loan under consideration.

25. The data processing system of claim 21, wherein the performance metric is the expected financial performance of the loan under consideration.

26. The data processing system of claim 25, wherein the financial performance of the loan under consideration is an expected financial loss or an expected financial gain.

27. A computer implemented method for assessing a performance metric of a loan under consideration, the method comprising:
a. receiving at least one characteristic model corresponding to at least one reference loan;
b. based on at least one received characteristic model, computing at least one characteristic model for the loan under consideration;
c. Based on at least one characteristic model computed for the loan under consideration, assessing the performance metric of the loan under consideration.

28. The computer implemented method of claim 27, wherein the performance metric is the risk of default of the loan under consideration.

29. The computer implemented method of claim 27, wherein the performance metric is the risk of noncompliance of the loan under consideration with at least one government or market requirement.

30. The computer implemented method of claim 27, wherein the performance metric is the risk of incidence of fraudulent activity associated with the loan under consideration.

31. The computer implemented method of claim 27, wherein the performance metric is the expected financial performance of the loan under consideration.

32. The computer implemented method of claim 31, wherein the financial performance of the loan under consideration is an expected financial loss or an expected financial gain.
